(19) United States
(12) Patent Application Publication
(10) Pub. No.: US 2026/0238557 A1
(43) Pub. Date: Aug. 13, 2026

(54) METHOD, USER EQUIPMENT AND ACCESS NETWORK NODE

(71) Applicant: NEC Corporation, Tokyo (JP)

(72) Inventors: Xuelong WANG, Guildford (GB); Pravjyot DEOGUN, Milton Keynes (GB); Neeraj GUPTA, London (GB); Hisashi FUTAKI, Tokyo (JP)

(73) Assignee: NEC Corporation, Tokyo (JP)

(21) Appl. No.: 19/158,069

(22) PCT Filed: Feb. 6, 2024
(86) PCT No.: PCT/JP2024/003858

§ 371 Date: Aug. 20, 2025

(30) Foreign Application Priority Data
Feb. 24, 2023 (GB) 2302758.4

(51) Int. Cl. H04L 41/16; H04W 36/00

(52) U.S. Cl. CPC H04L 41/16; H04W 36/0072

(57) ABSTRACT

In a first example aspect, a method performed by a mobile device includes: running an artificial intelligence/machine learning (AI/ML) model, in a cell of a first access network node; receiving, from the first access network node, information for a handover from the first access network node to a second access network node, wherein the information for the handover includes information related to continuity of the running the AI/ML model; and initiating a process based on the information related to the continuity of the running the AI/ML model, and wherein at least one AI/ML model is received from the second access network node during or after the handover.

### TECHNICAL FIELD

The present disclosure relates to a method, a user equipment and an access network node.

### BACKGROUND ART

Under the 3rd Generation Partnership Project (3GPP) standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers.

### CITATION LIST

### Non Patent Literature

NPL 1: 3GPP TS 38.331 “Radio Resource Control (RRC) protocol specification” V17.3.0 (2022-12)

### SUMMARY OF INVENTION

### Technical Problem

Improved methods for propagating artificial intelligence and machine learning (AI/ML) models and associated information between the nodes of the communication network, and for improving continuity of AI/ML model usage following a handover procedure, are needed. For example, handover of the UE from a source base station to a target base station may occur, and the AI/ML models supported for use in a cell of the target base station may not be the same as the AI/ML models supported for use in a cell of the source base station. There is a need for improved methods for more efficiently and reliably enabling the UE to use an AI/ML model in a cell of the target base station following the handover.

One example of the object of the present disclosure is to provide a method, a user equipment and an access network node capable of enabling a UE to use an AI/ML model more efficiently and reliably.

### Solution to Problem

In a first example aspect, a method performed by a user equipment, UE, includes:
running an artificial intelligence or machine learning, AI/ML, model, in a cell of a first access network node;
receiving, from the first access network node, information for a handover from the first access network node to a second access network node, wherein the information for the handover includes information related to continuity of the running the AI/ML model; and
initiating a process based on the information related to the continuity of the running the AI/ML model.

In a second example aspect, a method performed by a first access network node includes:
transmitting, to a user equipment, UE which is running an artificial intelligence or machine learning, AI/ML, model, in a cell of the first access network node, information for a handover from the first access network node to a second access network node, wherein the information for the handover includes information related to continuity of the running the AI/ML model, and
wherein the information related to the continuity of the running the AI/ML model causes the UE to initiate a process for the continuity of the running the AI/ML model.

In a third example aspect, a method performed by a second access network node includes:
transmitting, to a first access network node, information for a handover from the first access network node to the second access network node, wherein the information for the handover includes information related to continuity of running, by a user equipment, UE, an artificial intelligence or machine learning, AI/ML, model, in a cell of the first access network node, and
wherein the information related to the continuity of the running the AI/ML model is transmitted to the UE to cause the UE to initiate a process for the continuity of the running the AI/ML model.

In a fourth example aspect, a user equipment, UE, includes:
means for running an artificial intelligence or machine learning, AI/ML, model, in a cell of a first access network node;
means for receiving, from the first access network node, information for a handover from the first access network node to a second access network node, wherein the information for the handover includes information related to continuity of the running the AI/ML model; and
means for initiating a process based on the information related to the continuity of the running the AI/ML model.

In a fifth example aspect, a first access network node includes:
means for transmitting, to a user equipment, UE which is running an artificial intelligence or machine learning, AI/ML, model, in a cell of the first access network node, information for a handover from the first access network node to a second access network node, wherein the information for the handover includes information related to continuity of the running the AI/ML model, and
wherein the information related to the continuity of the running the AI/ML model causes the UE to initiate a process for the continuity of the running the AI/ML model.

In a sixth example aspect, a second access network node includes:
means for transmitting, to a first access network node, information for a handover from the first access network node to the second access network node, wherein the information for the handover includes information related to continuity of running, by a user equipment, UE, an artificial intelligence or machine learning, AI/ML, model, in a cell of the first access network node, and
wherein the information related to the continuity of the running the AI/ML model is transmitted to the UE to cause the UE to initiate a process for the continuity of the running the AI/ML model.

### Advantageous Effects of Invention

According to the present disclosure, it is possible to provide a method, a user equipment and an access network node capable of enabling a UE to use an AI/ML model more efficiently and reliably.

### BRIEF DESCRIPTION OF DRAWINGS

Example embodiments of the present disclosure will now be described, by way of example, with reference to the accompanying drawings in which:

FIG. 1 schematically illustrates a mobile (‘cellular’ or ‘wireless’) telecommunication system;

FIG. 2 illustrates a typical frame structure that may be used in the telecommunication system of FIG. 1;

FIG. 3 is a schematic block diagram illustrating the main components of a distributed unit (DU) 50 that may be used as part of the RAN equipment 5 for the communication system 1 shown in FIG. 1;

FIG. 4 is a schematic block diagram illustrating the main components of a central unit (CU) 60 that may be used as part of the RAN equipment 5 for the communication system 1 shown in FIG. 1;

FIG. 5 shows a mobility procedure in which handover occurs from a source (R)AN node to a target (R)AN node;

FIG. 6 shows a random access (RA) procedure that may be performed in the system of FIG. 1;

FIG. 7 shows a schematic illustration of point to point and point to multipoint transmissions;

FIG. 8 illustrates a framework in respect of an AI/ML model;

FIG. 9 shows an illustration of a method of training an AI/ML model, and of monitoring the performance of the AI/ML model;

FIG. 10 shows an example of an AI/ML request and an AI/ML response;

FIG. 11 shows an example of an AI/ML information update;

FIG. 12 shows an example of a method in which the base station broadcasts an indication of supported AI/ML models;

FIG. 13 shows an example in which an AI/ML model is transmitted to the UE from an AI/ML server via a base station;

FIG. 14 shows an example in which an AI/ML model is transmitted to the UE from a CU of a distributed base station via a DU;

FIG. 15 shows an example of AI/ML model function areas;

FIG. 16 illustrates a method in which AI/ML model area information is received by a UE;

FIG. 17 illustrates a modified version of FIG. 5, in which various steps of the method have been modified to include transmission of an AI/ML model and/or AI/ML model related information;

FIG. 18 is a schematic block diagram illustrating the main components of a UE for the telecommunication system of FIG. 1;

FIG. 19 is a schematic block diagram illustrating the main components of a base station for the telecommunication system of FIG. 1; and

FIG. 20 is a schematic block diagram illustrating the main components of a core network node or function for the telecommunication system of FIG. 1.

### DESCRIPTION OF EMBODIMENTS

The present disclosure relates to a communication system. The disclosure has particular but not exclusive relevance to wireless communication systems and devices thereof operating according to the 3GPP standards or equivalents or derivatives thereof (including LTE-Advanced, Next Generation or 5G networks, future generations, and beyond). The disclosure has particular, although not necessarily exclusive, relevance to AI/ML models used in ‘New Radio’ systems (also referred to as ‘Next Generation’ systems), and similar systems.

### RELATED ARTS

Recent developments of the 3GPP standards are referred to as the Long-Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term RAN node, base station, or access network node to refer to any such access nodes.

Some of the additional developments in 3GPP relate to the use of artificial intelligence (AI) and machine learning (ML), often abbreviated to AI/ML. Predictions or inferences generated using an AI/ML model can be used as part of various methods for improving the reliability or efficiency of communications in the network. For example, AI/ML models can be used to predict the path of a UE based on previous mobility of the UE, used for beam management, or used in methods of encoding and transmitting information. An AI/ML model may be hosted at a base station, and the base station may perform control of communication resources or control related to the status of a UE (e.g. control of UE mobility, or control of a radio resource control, RRC, state of the UE) based on an inference (e.g determination or prediction) generated using the AI/ML model. The base station may also transmit an inference generated using the model to another node in the network, for use at the other node.

Alternatively, an AI/ML model may be hosted at two nodes of the network, for example at a base station and at a UE. In this case, the base station and the UE may both make determinations or predictions using the model. For example, the UE may use the model as part of an encoding process for encoding (and/or compressing) channel state information (CSI) for transmission to the base station, and the base station may use the same model as part of a corresponding decoding (and/or decompression) process for decoding the CSI received from the UE.

### Problem of Related Arts

Improved methods for propagating AI/ML models and associated information between the nodes of the communication network, and for improving continuity of AI/ML model usage following a handover procedure, are needed. For example, handover of the UE from a source base station to a target base station may occur, and the AI/ML models supported for use in a cell of the target base station may not be the same as the AI/ML models supported for use in a cell of the source base station. There is a need for improved methods for more efficiently and reliably enabling the UE to use an AI/ML model in a cell of the target base station following the handover.

Moreover, there is also a problem that the transmission of an AI/ML model to the UE (for example, from the source base station) may be interrupted by the handover procedure. Methods for mitigating against such interruptions are needed.

More generally, there is a need for improved methods for enabling more efficient and reliable transmission of AI/ML models and related information between nodes in the communication network.

### Description of Aspects

The present disclosure describes multiple aspects and variants for each instance. These aspects and variants can be arbitrarily combined with each other.

In a first aspect the disclosure provides a method performed by a first access network node, the method comprising: determining that a user equipment, UE, is to be handed over from the first access network node to a second access network node; transmitting, to the second access network node, a handover request for handover of the UE to the second access network node; and receiving, from the second access network node, model information indicating one or more models, or one or more parameters for use with a model, for use by the UE after the handover to the second access network node, for generating a determination, prediction, or output parameter.

The one or more models may be artificial intelligence or machine learning (AI/ML) models.

The model information may be received from the second access network node in a handover request acknowledgement message.

The model information may be received from the second access network node in a setup message, or an update message, for transferring data via an interface between the first access network node and the second access network node.

The model information may be received from the second access network node in a dedicated information element.

The method may further comprise: determining, based on the model information received from the second access network node, a model for use by the UE after the handover of the UE to the second access network node; and performing at least one of: transmitting, to the UE, at least one of: an indication of the identity of the model for use by the UE after the handover to the second access network node, the model for use by the UE after the handover to the second access network node, or information for use by the UE to obtain the model for use by the UE after the handover to the second access network node; transmitting, to the second access network node, an indication that the second access network node is to transmit the model to the UE; or transmitting, to a server or core network node, an indication that the server or core network node is to transmit the model to the UE.

The method may comprise: transmitting the model, for use by the UE after the handover, to the UE in an RRC reconfiguration message; or transmitting the information for use by the UE to obtain the model in an RRC reconfiguration message.

The method may comprise: receiving, from the second access network node, the model for use by the UE after the handover of the UE to the second access network node, and transmitting the model to the UE; or receiving, from the second access network node, the information for use by the UE to obtain the model for use by the UE after the handover to the second access network node, and transmitting, to the UE, the information for use by the UE to obtain the model.

The information for use by the UE to obtain the model may comprise information for use by the UE to obtain the model from a server or core network node.

The method may comprise transmitting, to the second access network node, an indication of one or more models that are available for use by the UE before the handover to the second access network node, for generating a determination, prediction, or output parameter.

The indication of the one or more models that are available for use by the UE before the handover may comprise an indication of one or more models that are supported for a particular use case or feature.

The indication of the one or more models that are available for use by the UE before the handover may comprise a model identity or model version number.

The indication of the one or more models that are available for use by the UE before the handover may comprise an indication that a cell of the first access network node is part of an area that is associated with a respective set of one or more models for generating a determination, prediction, or output.

The indication of one or more models that are available for use by the UE before the handover may be included in the handover request transmitted from the first access network node to the second access network node.

The method may comprise transmitting, to the second access network node, the indication of one or more models that are available for use by the UE before the handover in a setup message, or an update message, for transferring data via an interface between the first access network node and the second access network node.

The method may comprise transmitting, to the second access network node, a dedicated information element for indicating the one or more models that are available for use by the UE before the handover.

The model information indicating the one or more models, or the one or more parameters for use with a model, for use by the UE after the handover may comprise at least one of: an indication of a model use case or function that is supported by the second access network node; a model identity or version number of the one or more models for use by the UE after the handover; or an indication that a cell of the second access network node is part of an area that is associated with a respective set of one or more models for generating a determination, prediction, or output.

The model information indicating the one or more models for use by the UE after the handover may comprise an indication of a plurality of models that may be used by the UE for a particular use case or function, after the handover.

The method may further comprise transmitting, to the UE, an indication that the UE is to continue to use a model for a particular use case or function after the handover to the second access network node.

The method may further comprise: receiving, from the second access network node, a request for the first access network node to transmit, to the second access network node, a model for use by the UE after the handover to the second access network node for generating a determination, prediction, or output parameter; and transmitting the requested model to the second access network node.

The method may further comprise: determining, based on the model information received from the second access network node, that a model is not to be used by the UE, or is to be disabled; and transmitting, to the UE, an indication that the model is not to be used by the UE, or is to be disabled.

The model information received from the second access network node may comprise information indicating one or more parameters for use, by the UE, with a model after handover of the UE to the second access network node; and the method may further comprise: transmitting, to the UE, an indication of the one or more parameters for use, by the UE, with the model after the handover; or transmitting, to the UE, the one or more parameters for use, by the UE, with the model after the handover.

Transmitting the indication of the one or more parameters, or the one or more parameters, to the UE may comprise transmitting the indication of the one or more parameters, or the one or more parameters, to the UE in an RRC reconfiguration message.

In another aspect the disclosure provides a method performed by a second access network node, the method comprising: receiving, from a first access network node, a handover request for handover of the UE from the first access network node to the second access network node; and transmitting, to the first access network node, model information indicating one or more models, or one or more parameters for use with a model, for use by the UE after the handover to the second access network node, for generating a determination, prediction, or output parameter.

The one or more models may be artificial intelligence or machine learning (AI/ML) models.

Transmitting the model information may comprise transmitting the model information to the first access network node in a handover request acknowledgement message.

Transmitting the model information may comprise transmitting the model information to the first access network node in a setup message, or an update message, for transferring data via an interface between the first access network node and the second access network node.

Transmitting the model information may comprise transmitting the model information to the first access network node in a dedicated information element.

The method may further comprise receiving, from the first access network node, an indication that the second access network node is to transmit a model to the UE, or is to transmit information for obtaining the model to the UE, wherein the model is for use by the UE after the handover of the UE to the second access network node.

The method may comprise: transmitting, to the first access network node, a model for use by the UE after the handover of the UE to the second access network node; or transmitting, to the first access network node, information for use by the UE or for use by the first access network node to obtain the model for use by the UE after the handover to the second access network node.

The information for use by the UE or for use by the first access network node to obtain the model may comprise information for obtaining the model from a server or core network node.

The method may comprise receiving, from the first access network node, an indication of one or more models that are available for use by the UE before the handover to the second access network node, for generating a determination, prediction, or output parameter.

The method may further comprise determining the one or more models for use by the UE after the handover based on the indication of the one or more models that are available for use by the UE before the handover.

The model information indicating the one or more models, or one or more parameters for use with a model, for use by the UE after the handover may comprise at least one of: an indication of a model use case or function that is supported by the second access network node; a model identity or version number of the one or more models for use by the UE after the handover; or an indication that a cell of the second access network node is part of an area that is associated with a respective set of one or more models for generating a determination, prediction, or output.

The model information may comprise an indication of a plurality of models that may be used by the UE for a particular use case or function, after the handover.

The method may further comprise receiving, from the UE, an indication of a model of the plurality of models that may be used by the UE for a particular use case or function, to be used by the UE after the handover.

The method may further comprise: transmitting, to the first access network node, a request for the first access network node to transmit, to the second access network node, a model for use by the UE after the handover to the second access network node for generating a determination, prediction, or output parameter; and receiving the requested model from the first access network node.

The model information transmitted to the first access network node may comprise information indicating one or more parameters for use, by the UE, with a model after handover of the UE to the second access network node.

In another aspect the disclosure provides a method performed by a user equipment, UE, the method comprising: receiving, from a first access network node, model information that indicates a model for use by the UE, after a handover of the UE to a second access network node, to generate a determination, prediction, or output parameter, wherein the model information comprises at least one of: an indication of an identity of the model for use by the UE after handover of the UE to the second access network node, one or more parameters of the model for use by the UE after the handover to the second access network node, the model for use by the UE after the handover to the second access network node, or information for use by the UE to obtain the model; and performing a handover procedure for handover of the UE from the first access network node to the second access network node.

The model may be an artificial intelligence or machine learning, AI/ML, model.

In a case where the model information comprises the information for use by the UE to obtain the model, the method may further comprise obtaining the model.

Obtaining the model may comprise obtaining the model from a server, a core network node, or the second access network node.

The method may further comprise using the model, after the handover of the UE from the first access network node to the second access network node, to generate a determination, prediction, or output parameter.

The method may further comprise configuring the model, before the handover of the UE to the second access network node, for use at the UE.

The model information may comprise an indication of a plurality of models that may be used by the UE for a particular use case or function, after the handover; and the method may further comprise: determining a model of the plurality of models to use for the use case or function; and transmitting, to the second access network node: an indication that the UE is to use the determined model for the use case or function; or a request for the UE to use the determined model for the use case or function.

The method may comprise: receiving, from the first access network node, an indication that the UE is to continue to use a model for a particular use case or function after the handover to the second access network node; and continuing to use the model for the use case or function after the handover to the second access network node.

The method may further comprise: receiving, from the first access network node, an indication that a model is to be disabled; and disabling use of the model at the UE before the handover to the second access network node.

The method may comprise receiving, from the first access network node, information indicating one or more parameters for use, by the UE, with a model after handover of the UE to the second access network node; and using the one or more parameters with the model after handover of the UE to the second access network node.

The method may further comprise determining, before the handover, to maintain a model in a memory of the UE during the handover of the UE to the second access network node.

The method may further comprise transmitting, to the second access network node: the model to be used by the UE after the handover of the UE to the second access network node; or information for use by the second access network node to obtain the model to be used by the UE after the handover of the UE to the second access network node.

In another aspect the disclosure provides a first access network node comprising: means for determining that a user equipment, UE, is to be handed over from the first access network node to a second access network node; means for transmitting, to the second access network node, a handover request for handover of the UE to the second access network node; and means for receiving, from the second access network node, model information indicating one or more models, or one or more parameters for use with a model, for use by the UE after the handover to the second access network node, for generating a determination, prediction, or output parameter.

In another aspect the disclosure provides a second access network node comprising: means for receiving, from a first access network node, a handover request for handover of the UE from the first access network node to the second access network node; and means for transmitting, to the first access network node, model information indicating one or more models, or one or more parameters for use with a model, for use by the UE after the handover to the second access network node, for generating a determination, prediction, or output parameter.

In another aspect the disclosure provides a user equipment, UE, comprising: means for receiving, from a first access network node, model information that indicates a model for use by the UE, after a handover of the UE to a second access network node, to generate a determination, prediction, or output parameter, wherein the model information comprises at least one of: an indication of an identity of the model for use by the UE after handover of the UE to the second access network node, one or more parameters of the model for use by the UE after the handover to the second access network node, the model for use by the UE after the handover to the second access network node, or information for use by the UE to obtain the model; and means for performing a handover procedure for handover of the UE from the first access network node to the second access network node.

### Overview

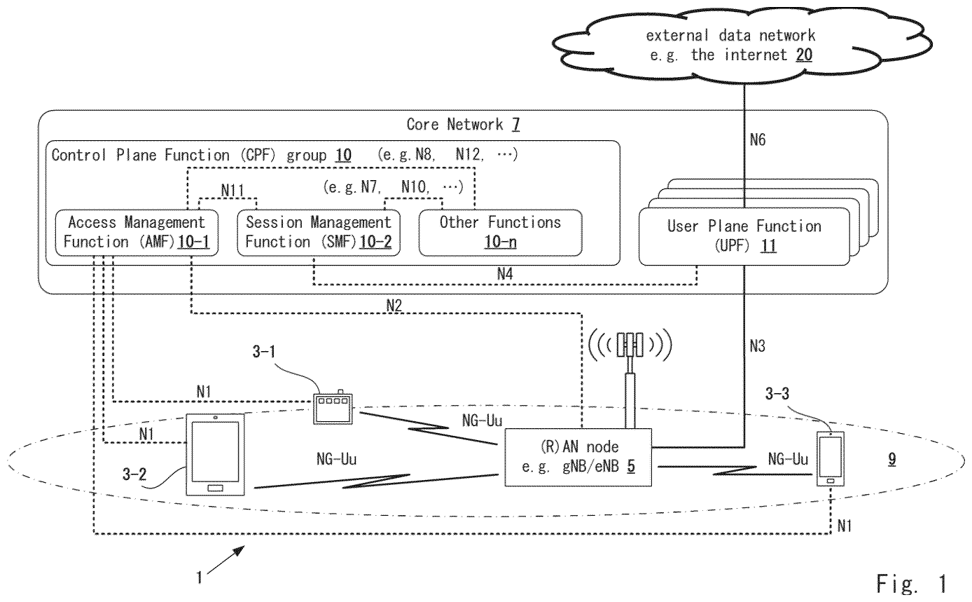

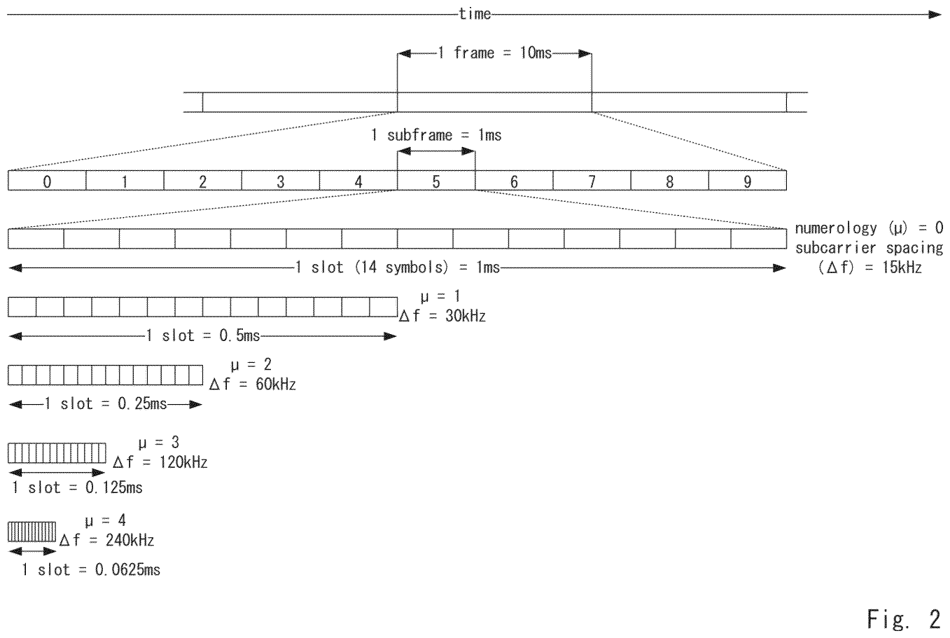

An exemplary communication system will now be described in general terms, by way of example only, with reference to FIGS. 1 and 2.

FIG. 1 schematically illustrates a mobile (‘cellular’ or ‘wireless’) communication system 1 to which example embodiments of the present disclosure are applicable.

In the communication system 1 user equipment (UEs) 3-1, 3-2, 3-3 (e.g. mobile telephones and/or other mobile devices) can communicate with each other via a radio access network (RAN) node 5 (base station 5, RAN equipment 5) that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g. a 5G core network or evolved packet core network (EPC)).

As those skilled in the art will appreciate, whilst three UEs 3 and one base station 5 are shown in FIG. 1 for illustration purposes, the system, when implemented, will typically include other base stations 5 and UEs 3.

Each base station 5 controls the one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) and a number of other functions 10-n.

The base station 5 is connected to the core network nodes via appropriate interfaces (or ‘reference points’) such as an N2 reference point between the base station 5 and the AMF 10-1 for the communication of control signaling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

The one or more UPFs 11 are connected to an external data network 20 (e.g. an IP network such as the internet) via reference point N6 for communication of the user data.

The AMF 10-1 performs mobility management related functions, maintains the NAS signaling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block, MIB. It also, in conjunction with the PDCCH, supports the synchronisation of time and frequency, which aids cell acquisition, selection and re-selection.

The UE 3 may receive a Synchronization Signal Block (SSB), and the UE 3 may assume that reception occasions of a PBCH, primary synchronization signal (PSS) and secondary synchronization signal (SSS) are in consecutive symbols and form a SS/PBCH block. The base station 5 may transmit a number of synchronization signal (SS) blocks corresponding to different DL beams. The total number of SS blocks may be confined, for example, within a 5 ms duration as an SS burst. The periodicity of the SSB transmissions may be indicated to the UE using any suitable signaling (e.g. per serving cell using ssb-periodicity ServingCell). The periodicity value for the SSB may be, for example, greater than or equal to 20 ms. For initial cell selection, the UE 3 may be configured to assume that an SS burst occurs with a periodicity of 2 frames. The UE 3 may also be provided with an indication of which SSBs within a 5 ms duration are transmitted (e.g. using ssb-Positions InBurst).

The DL physical signals may include, for example, reference signals (RSS) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for a UL control/data signal, and/or sounding reference signals (SRS) used for UL channel measurement.

When the UE 3 initially establishes a radio resource control (RRC) connection with a base station 5 via a cell 9 it registers with an appropriate core network node (e.g, AMF, MME). The UE 3 is in the so-called RRC connected state and an associated UE context is maintained by the network. When the UE 3 is in the so-called RRC idle state, or is in the RRC inactive state, it selects an appropriate cell for camping so that the network is aware of the approximate location of the UE 3 (although not necessarily on a cell level).

The base station 5 may be a base station 5 that is split between one or more distributed units (DUs) 50 and a central unit (CU) 60, with a CU 60 typically performing higher level functions and communication with the next generation core, and with the DU 50 performing lower level functions and communication over an air interface with UEs 3 in the vicinity (i.e. in a cell operated by the base station 5). This type of base station 5 may be referred to as a ‘distributed’ base station 5 or gNB 5. A distributed gNB 5 includes the following functional units:
gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.
gNB Distributed Unit (gNB-DU): a logical node hosting Radio Link Control (RLC), Medium Access Control (MAC) and Physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.
gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.
gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the control-plane and user-plane entities may each include an associated transceiver circuit, antenna, network interface, controller, memory, operating system, and communications control module. When the base station 5 comprises a distributed base station, the network interface also includes an E1 interface and an F1 interface (F1-C for the control plane and F1-U for the user plane) to communicate signals between respective functions of the distributed base station.

### (Frame Structure)

Referring to FIG. 2, which illustrates a typical frame structure that may be used in the communication system 1, the base station 5 and UEs 3 of the communication system 1 communicate with one another using resources that are organized, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2^{μ} kHz). The relationship between the parameter, μ, and SCS (Δf) is as shown in Table 1:

TABLE 1

| | Δf = 2^{μ} · 15 | Number of slots | Slot |
|---|---|---|---|
| μ | [kHz] | per subframe | length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

The table 1 shows one example of 5G Numerology.

### (RAN Equipment)

### <DU>

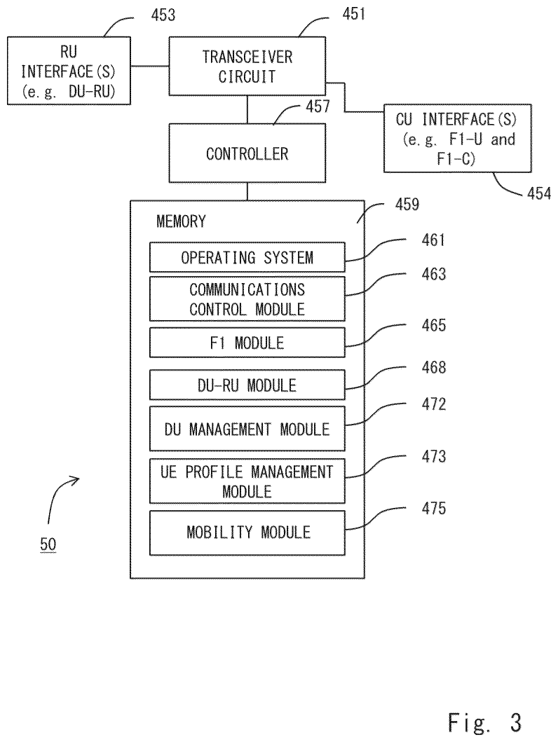

FIG. 3 is a schematic block diagram illustrating the main components of a DU 50 that may be used as part of the RAN equipment 5 for the communication system 1 shown in FIG. 1. As shown, the DU 50 has a transceiver circuit 451 for: transmitting signals to, and for receiving signals from, the communication devices (such as UEs 3) via the radio unit (RU) and the associated DU-RU interface 453; and for transmitting signals to, and for receiving signals from, the CU 60 of the RAN equipment 5 via a CU interface 454 (e.g. comprising an F1 interface which may be split into an F1-U and an F1-C interface for user plane and control plane signaling respectively).

The DU 50 has a controller 457 for controlling the operation of the DU 50. The controller 457 is associated with a memory 459. Software may be pre-installed in the memory 459 and/or may be downloaded via the communication system 1 or from a removable data storage device (RMD) for example. The controller 457 is configured to control the overall operation of the DU 50 by, in this example, program instructions or software instructions stored within the memory 459.

As shown, these software instructions include, among other things, an operating system 461, a communications control module 463, an F1 module 465, a DU-RU module 468, a DU management module 472, a UE profile management module 473 and a mobility module 475.

The communications control module 463 is operable to control the communication between the DU 50 and one or more RUs (and hence between the DU 50 and the UE 3), and between the DU 50 and the CU 60. The communications control module 463 is configured for the overall control of the reception of signals corresponding to uplink communications from the UE 3 and for handling the transmission of downlink communications to the UE 3.

The F1 module 465 is responsible for the appropriate processing of signals received from, or transmitted to, the CU 60 via one or more CU (e.g. F1) interfaces 454. These signals may be separated into: user plane signals received from, or transmitted to, the CU-UP part of the CU 60 via the F1-U interface; and control plane signals received from, or transmitted to, the CU-CP part of the CU 60 via the F1-C interface.

The DU-RU module 468 is responsible for the appropriate processing of signals received from, or transmitted to, the RU via one or more RU (e.g. DU-RU) interfaces 453.

The DU management module 472 is responsible for managing the overall operation of the DU 50 and the overall performance of the tasks required of the DU 50. These tasks include, among other things, the generation and transmission of appropriate messages using appropriate signaling application protocols, depending on the functional split between the RU, DU 50 and CU 60, such as interpretation of received MAC signaling and the generation of MAC signaling for transmission. The DU management module 472 may control the overall operation of the DU 50 in accordance with any of the methods describe below, where appropriate.

The UE profile management module 473 is responsible for carrying out functions related to the UE profile including (where applicable): the reception and storage of the UE profile or related assistance/preference information from the UE 3 or from elsewhere in the network; the determination (where applicable) of appropriate mobility specific configurations, based on the UE profile/assistance information/preference information, for implementation at the UE 3 and/or RAN equipment; and/or the provision of configuration information (where applicable) for configuring the UE appropriately with mobility based configurations. The UE profile management module 473 may also store, for example, previous mobility information for a UE 3 (e.g. previous movements of the UE 3 between different communication cells of the network). It will be appreciated that, depending on implementation, the gNB-DU may not implement at least some of these features.

The mobility module 475 is responsible for controlling mobility procedures for one or more UEs 3. For example, the mobility module 475 may be configured to perform one or more measurements for UE 3 mobility, or to select a candidate cell for handover.

### <CU>

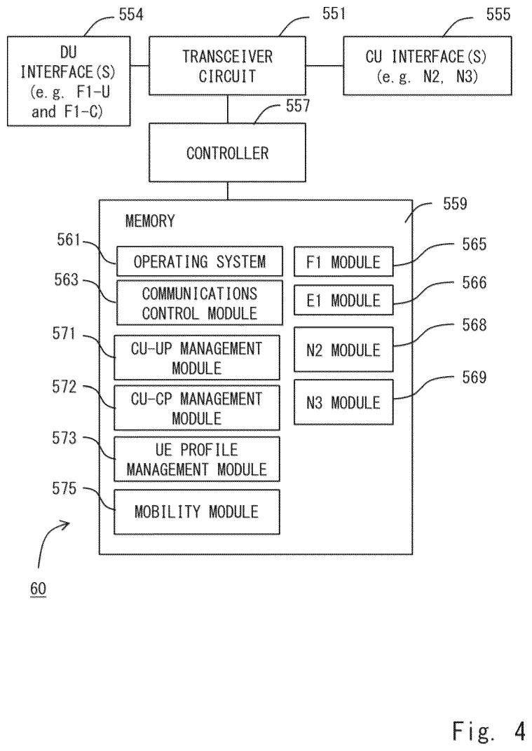

FIG. 4 is a schematic block diagram illustrating the main components of the CU 60 of the RAN equipment for the communication system 1 shown in FIG. 1. As shown, the CU 60 has a transceiver circuit 551 for: transmitting signals to, and for receiving signals from, the DU 50 via one or more DU interfaces 554 (e.g. comprising an F1 interface which may be split into an F1-U and an F1-C interface for user plane and control plane signaling respectively); and for transmitting signals to, and for receiving signals from, the functions of the core network 7 via one or more CU interfaces 555 (e.g. comprising the N2 and N3 interfaces or the like).

The CU 60 has a controller 557 to control the operation of the CU 60. The controller 557 is associated with a memory 559. Software may be pre-installed in the memory 559 and/or may be downloaded via the communication system 1 or from a removable data storage device (RMD) for example. The controller 557 is configured to control the overall operation of the CU 60 by, in this example, program instructions or software instructions stored within the memory 559.

As shown, these software instructions include, among other things, an operating system 561, a communications control module 563, an F1 module 565, an E1 module 566, an N2 module 568, an N3 module 569, a CU-UP management module 571, a CU-CP management module 572, a UE profile management module 573, and a mobility module 575. The functions of the mobility module 575 are the same as described above with reference to FIG. 3.

The communications control module 563 is operable to control the communication between the CU 60 and one or more DUs 50 (and hence between the CU 60 and the UE 3), and between the CU 60 and the core network 7. The communications control module 563 is configured for the overall control of the reception of signals corresponding to uplink communications from the UE 3 and for controlling the transmission of downlink communications.

The F1 module 565 is responsible for the appropriate processing of signals received from, or transmitted to, the DU 50 via one or more DU (e.g. F1) interfaces 554. These signals include: user plane signals received at, or transmitted by, the CU-UP part of the CU 60 via the F1-U interface; and control plane signals received at, or transmitted by, the CU-CP part of the CU 60 via the F1-C interface.

The E1 module 566 is responsible for the appropriate processing of signals transmitted between the CU-UP part of the CU 60 and the CU-CP part of the CU 60 via the corresponding internal CU interface (e.g. E1).

The N2 module 568 is responsible for the appropriate processing of signals received from, or transmitted to, the AMF 8-1 via one or more corresponding CU interfaces (e.g. N2) 555.

The N3 module 569 is responsible for the appropriate processing of signals received from, or transmitted to, one or more core network user plane functions via the one or more corresponding CU interfaces (e.g. N3) 555.

The CU-UP management module 571 is responsible for managing the overall operation of the CU-UP part of the CU 60 and the overall performance of the tasks required of the CU-UP.

The CU-CP management module 572 is responsible for managing the overall operation of the CU-CP part of the CU 60 and the overall performance of the tasks required of the CU-CP. These tasks include, among other things, the generation and transmission of appropriate messages using appropriate signaling application protocols, depending on the functional split between the RU, DU 50 and CU 60, such as interpretation of received RRC signaling and the generation of RRC signaling for transmission.

The UE profile management module 573 is responsible for carrying out functions related to the UE (mobility) profile including (where applicable): the reception and storage of the UE profile or related assistance/preference information from the UE 3 or from elsewhere in the network; the determination of appropriate mobility specific configurations, based on the UE profile/assistance information/preference information, for implementation at the UE 3 and/or RAN equipment 5; and/or the provision of configuration information for configuring the UE appropriately with mobility based configurations. The UE profile management module 573 may also store previous mobility information for a UE 3 (e.g. previous movements of the UE 3 between different communication cells of the network). It will be appreciated that, depending on implementation, the gNB-CU 60 may not implement at least some of these features.

### <System Information and SIB>

It will be appreciated that transmissions in a cell 9 of a base station 5 may include one or more broadcast transmissions, one or more unicast transmissions for reception by a UE 3, and/or one or more multicast transmissions for reception by a group of UEs 3. System information (SI) transmitted in a cell may include ‘minimum SI’ (MSI) and ‘other SI’ (OSI). The OSI may be broadcast on-demand, for example using a downlink shared channel (DL-SCH). The OSI may be broadcast upon request from a UE 3 that is in a radio resource control (RRC) idle or RRC inactive state. The OSI may also be requested by a UE 3 that is in the RRC connected state, for example via one or more dedicated RRC transmissions.

The SI may include information for enabling (e.g. configuring) the UE 3 to complete a cell selection, may include information for enabling the UE 3 to complete a cell reselection procedure, or for enabling the UE 3 to receive one or more paging messages transmitted in a cell. SI may be broadcast using a Master Information Block (MIB) and one or more System Information Blocks (SIB).

The MSI comprises the MIB and system information block 1 (SIB1). The MIB includes information for use by the UE 3 to receive SIB1, for example a subcarrier spacing for SIB1. The MIB provides information corresponding to a Control Resource Set (CORESET) and Search Space. SIB1 may be referred to as ‘remaining MSI’ (RMSI). SIB1 may be transmitted in a dedicated RRC message, and other SIB (e.g. SIB2 to SIB9) may be transmitting using one or more other suitable RRC transmissions (e.g. another dedicated RRC message).

The MIB and SIB1 may provide the UE 3 with an indication of scheduling information for receiving and decoding the other SIB, such as SIB2 to SIB9, and may provide information for use by the UE 3 to receive one or more paging messages. The OSI may comprise, for example, SIB2 to SIB9 transmitted using a DL-SCH in SI messages. A mapping of SIB2 to SIB9 to corresponding SI messages may be provided to the UE 3 by the base station 5. MIB and SIB1 to SIB9 are described in more detail, for example, in 3GPP Technical Specification (TS) 38.331. SIB2 provides information for intra-frequency, inter-frequency and inter-system cell reselection. SIB3 provides cell-specific information for intra-frequency cell reselection. SIB4 provides information for inter-frequency cell reselection. SIB5 provides information regarding inter-system cell reselection towards 4G (LTE). SIB6 and SIB7 provide information for an earthquake and tsunami warning system (ETWS). SIB8 provides information for a commercial mobile alert service (CMAS) notification, for example to provide warning text messages to the UE 3. SIB9 includes information regarding coordinated universal time (UTC), global positioning system (GPS) time (e.g. for GPS initialization) and local time.

SIB may be broadcast periodically (e.g. according to a predetermined periodic pattern), or alternatively may be provided ‘on-demand’, for example in response to a request from a UE 3. For example, MIB may be transmitted with a periodicity of 80 ms and repetitions made within 80 ms, and SIB1 may be transmitted with a periodicity of 160 ms and a variable transmission repetition periodicity within 160 ms (e.g. 20 ms). SIB1 can be used to indicate to a UE 3 which SIB are transmitted periodically and which SIB are available on-demand in response to a request from the UE 3. A UE 3 may be configured to request on-demand SIB using message 1 (MSG1), which may be referred to as a MSG1-based on-demand SI request, or message 3 (MSG3), which may be referred to as a MSG3-based on-demand SI request.

A physical broadcast channel (PBCH) can be used to broadcast the MIB. The base station 5 may transmit the PBCH with synchronization signals (SS) (e.g. primary synchronization signal (PSS) and secondary synchronization signal (SSS)) in a SS/PBCH Block. The SS/PBCH block comprises four orthogonal frequency-division multiplexed (OFDM) symbols that are mapped to PSS, SSS and PBCH associated with a demodulation reference signal (DM-RS). In the frequency domain, an SS/PBCH block comprises 240 contiguous subcarriers. When the UE 3 is in an RRC connected state, the base station 5 may provide the UE 3 with an indication of resources used for the SS/PBCH, for example using dedicated signaling. SIB1 may be transmitted using a physical downlink shared channel (PDSCH). The OSI may be similarly transmitted, for example, using a PDSCH. When one or more beamformed transmissions are transmitted in a cell provided by the base station 5, some of the SI (e.g. some of the SIB) may only be transmitted using particular beams, or using a particular transmission/reception point (TRP).

### (UE Mobility)

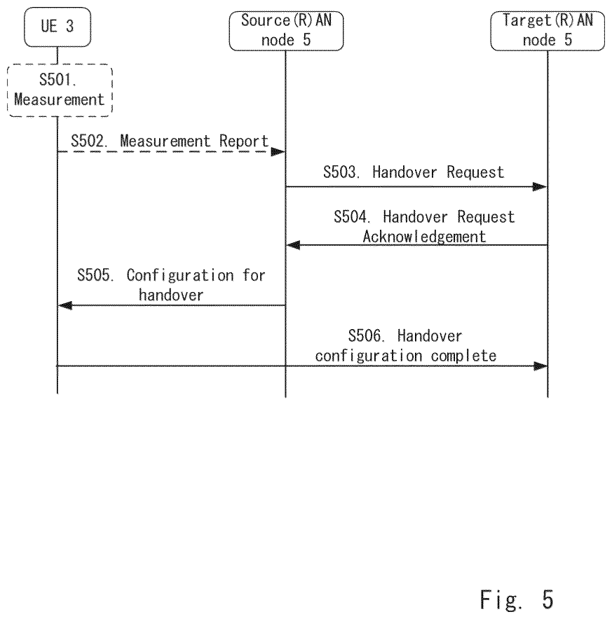

FIG. 5 shows an overview of a mobility procedure that may be performed in a communication system 1 of the type illustrated in FIG. 1. In this example, a handover of a UE 3 from a source base station 5 to a target base station 5 is performed.

In optional step S501 the UE 3 performs a measurement. The measurement may be a measurement of a signal transmitted by the source (R)AN node 5 or a measurement of a signal transmitted by the target (R)AN node 5. The measurement may be a measurement of a signal strength, that can be used as part of a determination that the UE 3 is to be handed over from the source (R)AN node 5 to the target (R)AN node.

In optional step S502 the UE 3 transmits a measurement report to the source (R)AN node 5 that provides an indication of the result of the measurement. The measurement report may be transmitted from the UE 3 to the source base station 5 in an RRC message. In this example the source (R)AN node uses the information provided in the measurement report to determine that the UE 3 is to be handed over to the target (R)AN node 5. However, it will be appreciated that a determination that handover to the target (R)AN node is to be performed may alternatively (or additionally) be based on a measurement performed at the source (R)AN node 5 or at the target (R)AN node 5. Alternatively, a determination that handover of the UE 3 is to be performed may be based on a factor other than a signal measurement, such as a level of congestion in a cell operated by the source (R)AN node 5, or an inference (e.g. determination or prediction) generated using an AI/ML model.

In Step S503 the source (R)AN node 5 transmits a handover request to the target (R)AN node 5, requesting handover of the UE 3 from the source (R)AN node 5 to the target (R)AN node 5. The handover request may include an indication of, for example, an identity of the source (R)AN node 5, a cause value for the handover, an identity of the target cell, UE 3 context information (e.g. a maximum bit rate of the UE 3, or security capabilities of the UE 3), and UE history information. If the handover has been triggered by the measurement report received by the source (R)AN node 5 in step S502, then the cause value may indicate, for example, that the handover is desirable for radio reasons. Alternatively, if the handover has been triggered to reduce the load at the source (R)AN node 5, the cause value may indicate that the handover is for reducing load in the serving cell. The handover request message may also include an indication of the AMF 10-1 that is serving the UE 3.

In step S504, the target (R)AN node transmits an acknowledgement of the handover request (which may be referred to as a “handover request acknowledgement” message). The handover request acknowledgement message includes an indication of handover configuration information for the handover that is to be forwarded to the UE 3. The handover request acknowledgement message may also include configuration information that enables the source (R)AN node 5 to begin forwarding user plane data for the UE 3 to the target (R)AN node 5.

The transmissions of steps S503 and S504 may be performed over an Xn interface between the source (R)AN node 5 and the target (R)AN node 5 (and therefore the handover procedure in this example may be referred to as an Xn-based handover procedure). Steps S501 to S504 may be referred to as a ‘handover preparation phase’.

In step S505, the source (R)AN node transmits the handover configuration information to the UE 3. The configuration information for the handover may be, for example, an RRC configuration transmitted in an RRC configuration message or an RRC reconfiguration message. In step S506, the UE 3 applies the received configuration for handover and transmits an indication to the target (R)AN node 5 that configuration for the handover is complete. The message transmitted in step S505 may be, for example, an RRC Reconfiguration Complete message. Steps S505 and S506 may be referred to as a ‘handover execution phase’.

Following the handover execution phase, the UE 3 is operable to transmit uplink transmissions to the target (R)AN node 5 (e.g uplink data) and receive downlink transmissions from the target (R)AN node 5 (e.g. downlink data).

It will be appreciated that mobility methods and handover procedures for the UE 3 are not restricted to the example illustrated in FIG. 5. For example, the UE 3 may be configured to perform a conditional handover (CHO) in which the UE 3 determines whether handover of the UE 3 to a candidate cell is to be performed based on one or more execution conditions. It will also be appreciated that handover may be performed in which the DU 50 changes but the CU 60 remains the same (inter-DU intra-CU handover), in which both the DU 50 and CU 60 change (inter-DU inter-CU handover), or between two cells operated by the same DU 50.

### (Random Access)

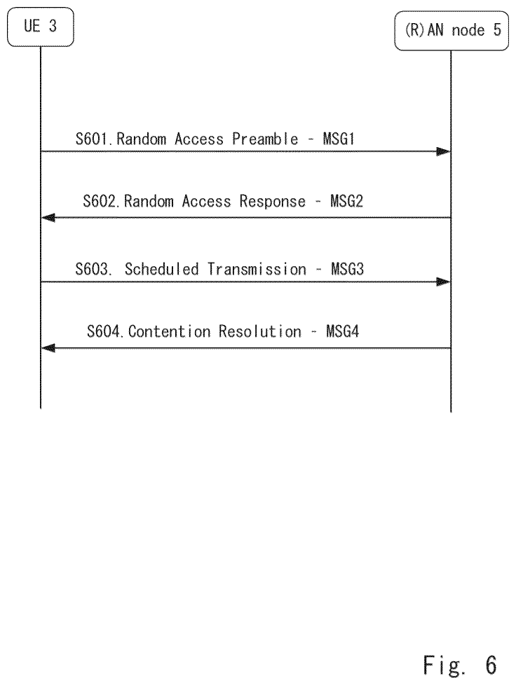

FIG. 6 shows a random access (RA) procedure that may be performed in the system of FIG. 1. The RA procedure can be used, for example, for initial access by a UE 3 that is in the RRC idle mode, or for a transition from the RRC inactive mode to the RRC connected mode. The RA procedure may also be used during handover of the UE 3 from a source base station to a target base station (e.g. the handover procedure described above with reference to FIG. 5), for initial access to the target base station 5.

In step S601 the UE 3 transmits a random access preamble to the base station 5. In this example the UE 3 selects the random access preamble to transmit from a group of random access preambles that are shared with other UEs 3. The transmission of step S601 may be referred to as message 1 (MSG1), and is transmitted using PRACH.

In step S602 the base station 5 transmits a random access response to the UE 3. The transmission of step S602 may be referred to as message 2 (MSG2). The random access response indicates time and/or frequency resources (e.g. resource blocks and/or symbols) for use by the UE 3 to transmit a subsequent transmission to the base station 5. The random access response may also include further information for use by the UE 3 for communication with the base station 5, such as a timing advance (TA) value.

In step S603 the UE 3 transmits a transmission to the base station 5 using the indicated time and/or frequency resources. The transmission of step S603 may be referred to as message 3 (MSG3). The transmission of step S603 may be a layer 2 (L2) or layer 3 (L3) message. The transmission of step S603 may comprise, for example, an RRC setup request, an RRC resume request, an RRC reestablishment request, or an RRC reconfiguration complete message.

If two UEs 3 selected and transmitted the same random access preamble in step S601, and receive and decode MSG2 transmitted by the base station 5 in step S602, then the two UEs may transmit MSG3 using the same time and/or frequency resources. This situation can be referred to as ‘contention’ or ‘collision’. In order to resolve the contention, in step S604 the base station 5 transmits a content resolution message to the UE 3. The transmission of step S604 may be referred to as message 4 (MSG4). MSG4 indicates to the UE 3 whether the MSG3 transmitted by the UE 3 in step S603 was received and successfully decoded by the base station. MSG3 transmitted in step S603 may not have been received or successfully decoded by the base station 5 if the base station 5 decoded a MSG3 transmitted by another UE 3 that is in contention with the UE 3, or if interference occurred between the MSG3 transmitted by the two UEs 3. If MSG3 transmitted by the UE 3 was not decoded by the base station 5 (which the UE 3 may determine if the UE 3 does not receive MSG4 from the base station 5), then the UE 3 returns to step S601 of the method and transmits another MSG1 to the base station 5 (e.g. after selecting a different random access preamble).

The procedure illustrated in FIG. 6 is an example of a contention based RA procedure in which the UE 3 selects the random access preamble from a group of preambles that could also be used by other UEs 3 (and therefore contention can occur if two of the UEs 3 select the same random access preamble). Alternatively, the base station 5 may transmit a random access preamble assignment to the UE 3 before the UE 3 transmits MSG 1 to the base station 5, in which case the RA procedure is contention free (and the contention resolution in step S604 need not be performed). The random access preamble assignment may be transmitted to the UE 3 using an RRC message or layer 1 (L1) signaling (e.g. using DCI carried by a PDCCH). In the method illustrated in FIG. 5, a random access preamble assignment for communication with the target base station 5 may be transmitted to the UE 3 in step S505.

MSG1 and/or MSG 3 may be used by the UE 3 to request on-demand SI from the base station 5.

### (Broadcasts and Multicasts)

A base station 5 may transmit a broadcast intended for reception by any UE 3 in a cell of the base station 5, or may transmit a transmission intended for reception by a particular UE 3 (a point to point, PTP, transmission). The base station 5 may also transmit a transmission intended for reception by a particular group of UEs 3 (a point to multiple, PTM, transmission). A transmission intended for reception by a single UE 3 may be referred to as a unicast transmission, and a transmission intended for reception by a group of UEs 3 may be referred to as a multicast transmission.

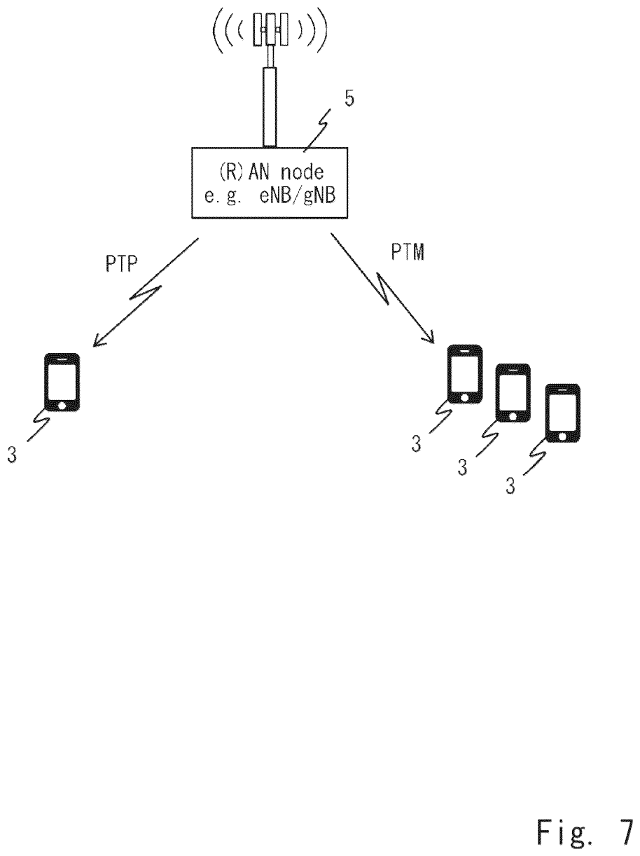

A multicast service may include a PTP leg between a base station 5 and a single UE 3, and a PTM leg between the base station 5 and a plurality of UEs 3. PTP and PTM transmissions are illustrated schematically in FIG. 7. It will be appreciated that whilst the UEs 3 are shown separately in FIG. 7, a UE 3 may receive both the PTP and PTM parts of the multicast. PTP may be described as a PTP ‘leg’ or ‘part’ of a multicast transmission. Similarly, PTM may be described as a PTM ‘leg’ or ‘part’ of a multicast transmission.

The PTM leg has an MBS radio bearer (MRB) that has a corresponding MRB configuration. Each MRB may have an associated identifier (e.g. MRB-Identity) that can be used to identify the MRB. The MRB identity may be included in any suitable transmission for MRB configuration. A multicast service may be suspended (a process in which MRBs are released) or re-activated based on multicast data activity (or inactivity). The configuration of one or more MRBs may be provided to the UE 3 and/or the base station using any suitable radio link control (RLC) configuration signaling (e.g. in an RLC Bearer Configuration message).

The base station 5 may provide a multicast MRB configuration to the UE 3 via dedicated signaling. The multicast MRB may be configured in a DL only RLC unacknowledge mode (RLC-UM), in which acknowledge/negative-acknowledge (ACK/NACK) feedback is not transmitted, or the MRB may have a bidirectional RLC-UM configuration for PTP transmission.

The multicast MRB configuration may include an RLC-acknowledge mode (RLC-AM) configuration for transmission of ACK/NACK feedback. The multicast MRB configuration may include an RLC-unacknowledge mode (RLC-UM) configuration in which ACK/NACK feedback is not transmitted.

The multicast MRB configuration may include an RLC-AM entity for PTP transmission. The multicast MRB configuration may include a DL only RLC-UM entity for PTM transmission.

The multicast MRB configuration may include two RLC-UM entities. One of the RLC-UM entities may be a DL only RLC-UM entity for PTP transmission, and the other RLC-UM entity may be a DL only RLC-UM entity for PTM transmission.

The multicast MRB configuration may include three RLC-UM entities, wherein one of the RLC-UM entities is a DL only RLC-UM entity, one of the RLC-UM entities is an UL RLC-UM entity for PTP transmissions, and the other RLC-UM entity is a DL only RLC-UM entity for PTM transmission.

The multicast MRB configuration may include two RLC entities, wherein one of the RLC entities is an RLC-AM entity for PTP transmission, and the other RLC entity is a DL only RLC-UM entity for PTM transmission.

### (Logical Channels and Logical Channel Priority)

A logical channel (LCH) may be a control channel for the transmission of control and/or configuration information (control plane information), or may be a channel used for transmission of user data (user plane information). Logical channels that may be used in the system illustrated in FIG. 1 include the broadcast control channel (BCCH), the paging control channel (PCCH), the common control channel (CCCH) used by the UE 3 during initial access, the dedicated control channel (DCCH) and the dedicated traffic channel (DTCH). One or more transport channels may also be used in the system of FIG. 1. Transport channels include the broadcast channel (BCH), paging channel (PCH), downlink shared channel (DLSCH), uplink shared channel (ULSCH) and random access channel (RACH). Mapping between the logical channels and the transport channels may be performed at the medium access control (MAC) layer, and multiple logical channels may be multiplexed for transmission using a transport channel (e.g. based on the priority of each logical channel, as described later). For example, the BCCH may be mapped to the BCH or the DLSCH, and the PCCH may be mapped to the PCH. The transport channels are mapped to corresponding physical channels (e.g: PDCCH, PDSCH or PBCH for downlink transmissions; or PUSCH, PUCCH or PUSCH for uplink transmissions).

A logical channel may be identified using a corresponding logical channel ID (LCID). A set of logical channels may be grouped into a logical channel group (LCG), which can be identified using a corresponding index (e.g. an index between 0 and 7).

A logical channel can be assigned a priority by the network (e.g. a transmission priority). For example, a logical channel being used for part of a handover procedure may be assigned a relatively high priority for transmission, since transmission delays in the handover procedure increase the likelihood of handover failure. The base station 5 may determine to preferentially include data (or other information) corresponding to a higher priority logical channel in a medium access control (MAC) protocol data unit (PDU) for transmission to the UE 3, rather than including data or other information corresponding to a lower priority logical channel. The base station 5 may also control the scheduling of uplink transmissions by the UE 3 based on the logical channel priorities.

A prioritized bit rate (PBR) may be defined for a logical channel. The prioritized bit rate may be configured by the base station 5. The prioritized bit rate is a bit rate configured for use for a higher priority logical channel, and the remaining available bit rate (or a portion of the remaining available bit rate) is configured for transmission of the lower priority logical channels. Use of the PBR beneficially helps to avoid a situation in which only the highest priority logical channels are transmitted.

### (Artificial Intelligence (AI)/Machine Learning (ML))

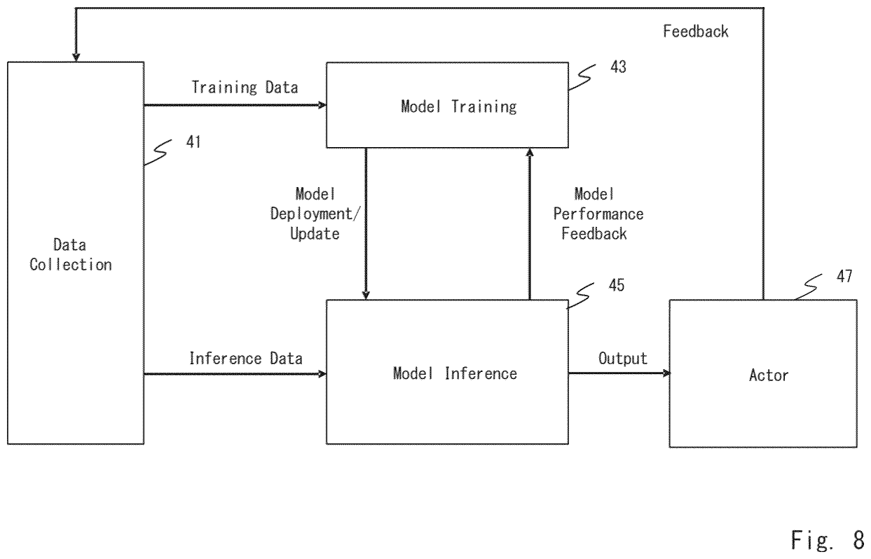

FIG. 8 illustrates a framework in respect of an AI/ML model, and how various entities of the framework may interact with one another.

The entities include a data collection function 41, a model training function 43, a model inference function 45, and an actor 47. The data collection function 41 provides input data (training data) to the model training function 43 and the model inference function 45. The collected data may be, for example, data regarding mobility (e.g. handover of a UE 3, or a location of the UE 3). For example, the data may be obtained by a base station 5 (e.g. by receiving a measurement report from a UE 3, or by receiving data from another base station 5 or a core network node/function) and transmitted to another base station 5 that generates the AI/ML model inference output (or alternatively, the same base station that obtains the data may generate the AI/ML model output). The model training function 43 performs the ML model training, validation, and testing, and may generate model performance metrics as part of a model testing procedure. The model inference function 45 provides AI/ML model inference output (e.g., predictions or decisions), and the actor 47 is a function or node that receives the output from the model inference function 45 and triggers or performs corresponding actions (e.g. a base station 5 that increases/reduces its transmit power, or initiates a handover procedure for a UE 3).

The AI/ML model inference output may be, for example, a prediction of mobility (e.g. expected path, route or trajectory, inter-cell or inter-beam mobility, or expected handover) of the UE 3, or one or more parameters for use in encoding or decoding transmissions between the base station 5 and the UE 3. The functions illustrated in FIG. 8 may be co-located at a single node of the communications network (e.g. at a base station 5 or core network node/function), or may be distributed amongst a plurality of network nodes (e.g. a plurality of base stations 5).

Terms referred to by 3GPP in the context of this framework include:
AI/ML Training: An online or offline process for training an AI/ML model.
AI/ML Validation: A method for evaluating the quality (e.g. prediction accuracy) of an AI/ML model using a dataset that is different from the one used for the training of the model.
AI/ML Model Testing: A method for evaluating the performance of a final AI/ML model, using a dataset different from the ones used for training and validation.
AI/ML Data Collection: A method of collecting data by network nodes, a management entity, and/or a UE 3, for training the AI/ML model, for data analytics (e.g. model performance monitoring), and/or for generating an inference using the AI/ML model.
Model Monitoring: A method of monitoring the inference performance (e.g. prediction accuracy) of the AI/ML model.
Training Data: Data for input to the AI/ML Model Training function.
Supervised Learning: A method of training an AI/ML model using labelled data.
Unsupervised Leaning: A method of training an AI/ML model using unlabeled data.
Semi-supervised Learning: A method of training an AI/ML model using both labelled and unlabeled data.
Inference Data: Data for input to the AI/ML Model Inference function, for generating an inference.
Model Deployment/Update: A method of deploying (e.g. transmitting to a network node) an AI/ML model to the Model Inference function, or of delivering an updated model to the Model Inference function.

The data collection function 41 may be performed at various nodes of the communication network (e.g. at one or more base stations 5 or UEs 3).

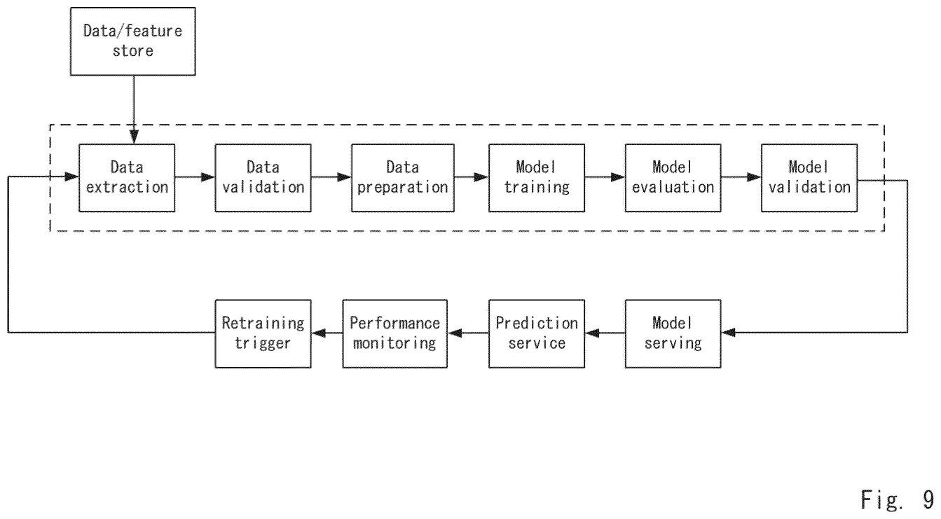

FIG. 9 shows an illustration of a method of training an AI/ML model, and of monitoring the performance of the AI/ML model. As illustrated in FIG. 9, stored data/features may first be extracted in a data extraction step. In the data validation step, a determination of whether to proceed with training or retaining the AI/ML model is made (e.g based on the extracted data). In the data preparation stage, the data is prepared for use in training the AI/ML model. For example, the data may be cleaned (e.g. filtered), subject to a transformation, or modified in any other suitable manner. The data may also be divided in training data, validation data and test data sets in the data preparation stage.

In the model training step, the AI/ML model is trained (or retrained) using training data prepared in the data preparation step. It will be appreciated that any suitable training method can be used to train the AI/ML model (e.g a method that comprises supervised learning or unsupervised learning). In the model evaluation step, the AI/ML model is evaluated (e.g. a prediction accuracy of the AI/ML model is evaluated) using a test data set (which may be generated in the data preparation step). In the model validation step, a determination of whether the AI/ML model is suitable for deployment in the communication network is made (e.g. based on the results of the model evaluation step).

In the model serving step, the AI/ML model is deployed for use in the communication system 1. AI/ML model deployment may comprise compiling a trained AI/ML model, packaging the model into an executable format, and delivering the AI/ML model to a target device. For example, the AI/ML model may be transmitted to the base station 5 and/or the UE 3, for use at the base station and/or the UE to generate predictions or determinations using the AI/ML model as part of a prediction service step, as illustrated in the figure.

In the performance monitoring step, the performance of the deployed AI/ML model is monitored. The predictive performance of the AI/ML model may be monitored by comparing predictions generated using the model with one or more measurements. For example, when the AI/ML model is used to predict a location of a UE 3, the prediction accuracy of the AI/ML model may be assessed using a measurement of an actual location of the UE 3. Alternatively, if the AI/ML model is used for determining parameters for use in encoding and decoding data transmitted between a base station 5 and a UE 3, the model may be assessed based on the performance of the encoding and/or decoding processes. In the retraining trigger step, retraining of the AI/ML model is triggered (e.g. because the prediction accuracy of the AI/ML model has fallen below an acceptable threshold accuracy, or because a performance of a method that uses inferences from the AI/ML model has fallen below an acceptable threshold performance), and the method returns to the data extraction step.

As described above with reference to FIG. 8, each step of the method of FIG. 9 may be executed at a single node of the communication system 1, or alternatively steps of the method may be distributed between a plurality of different nodes.

As discussed above with reference to FIGS. 8 and 9, information collected by nodes/functions in the communication network can be used as training data for an AI/ML model, and used as inference data for use in generating one or more model inferences using the AI/ML model. The information used as training data and/or to generating the one or more model inferences may be referred to as ‘AI/ML information’. Methods of requesting and transmitting AI/ML information will now be described.

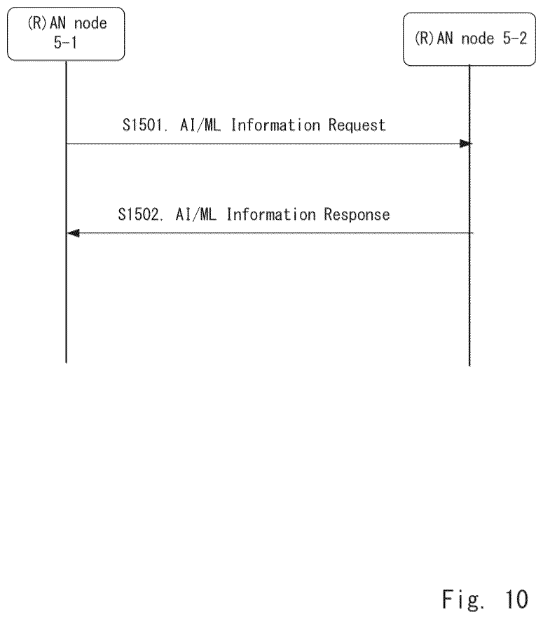

FIG. 10 shows an example of an AI/ML information request and an AI/ML response. In Step S1501, the first base station 5-1 transmits an AI/ML information request to the second base station 5-2. The AI/ML request is a request for AI/ML information (e.g. information regarding an actual mobility of a UE 3) from the second base station 5-2.

After receiving the AI/ML information request in step S1501, the second base station 5-2 transmits an AI/ML Information Response to the first base station 5-1 that includes the AI/ML information. The second base station 5-2 may also begin periodic reporting of the AI/ML information to the first base station 5-1 in response to receiving the AI/ML information request. The periodic reporting may be configured using a corresponding AI/ML information reporting configuration indicated by the AI/ML information request (e.g. including a periodicity of the reporting, number of reports, or reporting duration/time period). The AI/ML information request may include an information element (IE) that indicates that the second base station 5-2 is to start or stop periodic reporting of the AI/ML information to the first base station 5-1. The AI/ML information request may alternatively be a request for a single report of AI/ML information from the second base station 5-2, rather than for periodic reporting.

If the second base station 5-2 is unable to transmit the requested AI/ML information to the first base station 5-1 (e.g. because the requested information is not available at the second base station 5-2), then the base station 5-2 may transmit a corresponding indication to the first base station 5-1 that the second base station is unable to provide the requested information, for example an AI/ML information failure message. The AI/ML information failure message may include an indication of why the second base station 5-2 is unable to provide the requested AI/ML information (e.g. a cause value).

Upon receipt of the AI/ML information, the first base station 5-1 may use the AI/ML information to train (or update) a corresponding AI/ML model (e.g. for UE 3 mobility), or to generate a prediction (e.g a prediction of UE 3 mobility). Alternatively, the first base station 5-1 may forward the AI/ML information to another network node, for use with an AI/ML model at that network node.

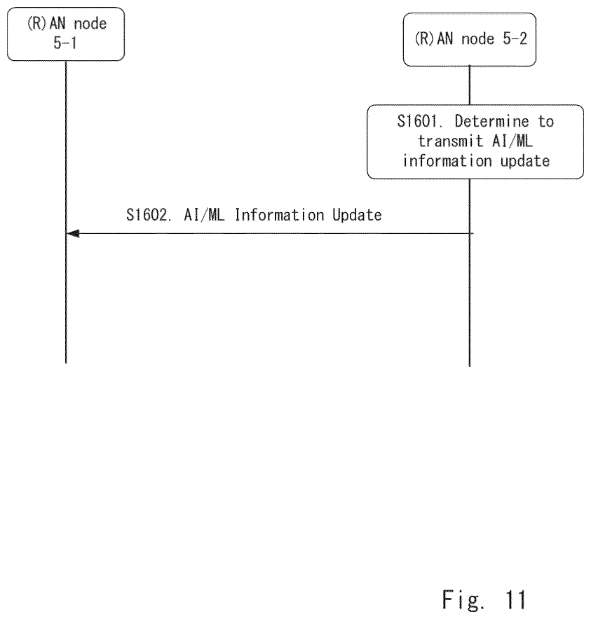

Whilst in the example shown in FIG. 10 the AI/ML information response may include the requested AI/ML information, alternatively the AI/ML information response may be an indication that the second base station 5-2 will transmit the AI/ML information in a subsequent AI/ML information update (e.g. an acknowledgement of the AI/ML information request). FIG. 11 shows an example of an AI/ML information update. In step S1601 the second base station 5-2 determines to transmit an AI/ML information update to the first base station 5. For example, the second base station 5-2 may determine to transmit the AI/ML information update to the first base station 5-2 based on a reporting periodicity received by the second base station 5-2 in step S1501 of FIG. 10, or may determine to transmit the AI/ML information update based on a change in AI/ML information stored at the second base station 5 (or based on AI/ML information obtained at the second base station 5-2). In step S1602 the second base station 5-2 transmits the AI/ML information to the first base station 5-1 in the AI/ML information update.

### <Distributed AI/ML Architecture>

Whilst the network may include a primary node/function that hosts the AI/ML model and generates the AI/ML model inferences, alternatively the AI/ML model may be distributed amongst various nodes in the network. For example, a plurality of base stations 5 may host the AI/ML model and generate inferences. Whilst this may increase the processing required at some network nodes, when the AI/ML model is distributed amongst the network nodes there is a reduction in the number of inferences that are transmitted between the nodes.

When the AI/ML model (or a plurality of AI/ML models—the same model need not necessarily be used at each node) is provided at a plurality of base stations 5, the feedback information can still be provided to each of the base stations that generates inferences using the AI/ML model (for example, to verify the accuracy of the model, as described above).

### <Configuration Information for AI/ML>

Configuration information for an AI/ML model (which may be referred to as “AI/ML configuration information”) may be exchanged between nodes in the communication network. For example, a core network node may transmit AI/ML configuration information to a base station 5 that hosts an AI/ML model.

The AI/ML configuration information may include a list of supported use cases for the AI/ML model (the AI/ML model need not necessarily be for predicting UE mobility). The supported use cases may be, for example: energy saving; traffic steering; anomaly detection; quality of experience (QoE) optimization; mobility robustness optimization (MRO); RAN slice service level agreement (SLA) assurance; massive multiple-input multiple-output (MIMO) beamforming optimization; network slice subnet instance (NSSI) resource allocation; optimization coverage and capacity optimization (CCO); mobility load balancing (MLB); RACH optimization; or UE transmission power optimization. The AI/ML configuration information may include an indication of a particular AI/ML model to use for a particular use case. The AI/ML configuration information may also include an indication of whether feedback is required (e.g. from another network node). The feedback may include, for example, communication performance feedback (e.g. indicating a communication performance for communication between a UE 3 and a base station 5).

When a plurality of AI/ML models are stored at a UE 3 (or base station 5, or other network node), the UE 3 may receive an indication of which of the AI/ML models to use. The UE 3 may receive (e.g. from a base station 5) an indication that use of a particular model is to be activated or deactivated (e.g. in response to a determination in the performance monitoring step of FIG. 9-a particular AI/ML model may be deactivated if the prediction accuracy has fallen below an acceptable accuracy threshold). The UE 3 may be provided with a plurality of AI/ML models, wherein each model is for use in a particular scenario or configuration.

### (Single-Sided and Two-Sided Models)

An AI/ML model may be hosted (stored, for generating inferences) at both a base station 5 and a UE 3, may be hosted at only the base station 5, or may be hosted at only the UE 3. When the AI/ML model is used at the UE 3 only, the AI/ML model may be referred to as a ‘single-sided’ model. For example, the UE 3 may host an AI/ML model for generating a time (e.g. time resource) for communication using a particular beam transmitted by the base station 5. However, even when the model is a single-sided model, it will be appreciated that the model need not necessarily be trained at the UE 3. For example, the model could be trained at the base station 5 or at another node in the network (e.g. core network node/function), and then transmitted to the UE 3 for use at the UE 3. In other words, the AI/ML model may be trained at another network node, and then transferred/deployed to the UE 3.

Alternatively, the AI/ML model may be a ‘two-sided’ model, in which an AI/ML model is hosted at the UE 3, and a corresponding AI/ML model is hosted at the base station 5 (however, the models need not necessarily be hosted at a UE 3 and a base station 5—any other suitable two network nodes could alternatively be used). The AI/ML model hosted at the UE 3 and the AI/ML model hosted at the base station 5 may be the same AI/ML model (but need not necessarily be the same model). The UE 3 can use the AI/ML model to generate a first inference, and the base station 5 can use the AI/ML model to generate a corresponding second inference. For example, the first inference may be an inference of a parameter to use for encoding or compressing data (e.g. channel state information (CSI)) to be transmitted from the UE 3 to the base station 5, and the second inference may be an inference of a parameter to use to decode or decompress the data at the base station 5. As with the single-sided model case, the two-sided model (or models) may be trained at any suitable network node, and then transmitted to the UE 3 and the base station 5.

### (AI/ML Model Acquisition)

Methods of AI/ML model deployment will now be described. In this example, the AI/ML model is transmitted to a UE 3, for use at the UE 3. The AI/ML model may be a two-sided model (in a case where a corresponding AI/ML model, or the same AI/ML model, is used at the base station 5), but could alternatively be an AI/ML model that is used at only the UE 3.

In this example, a broadcast transmission or a multicast transmission is used to transmit the AI/ML model to the UE 3 when the UE 3 is in the RRC idle state or the RRC inactive state. A multicast transmission and/or an RRC message (e.g. dedicated RRC message) is used to transmit the AI/ML model to the UE 3 when the UE 3 is in the RRC connected state.

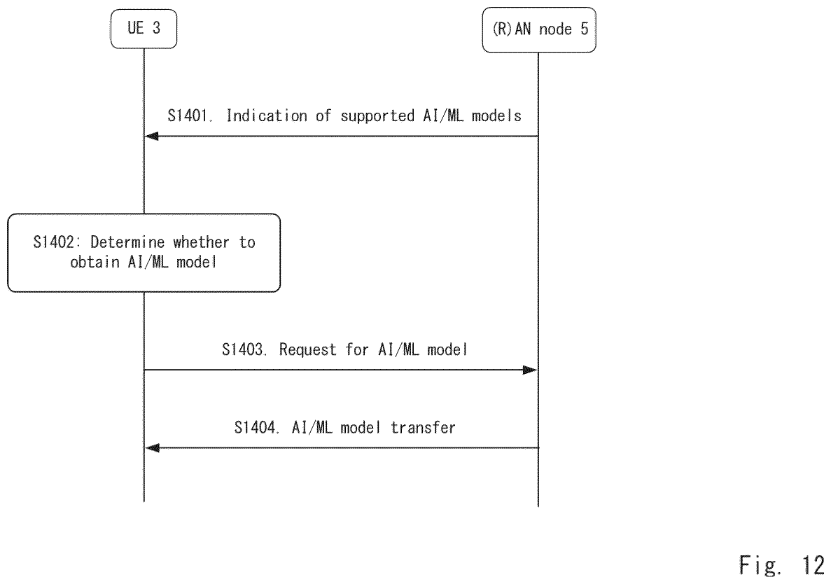

FIG. 12 shows an example of a method in which the base station 5 broadcasts an indication of supported AI/ML models.

In step S1401, the base station 5 broadcasts an indication of supported AI/ML models. In this example, the indication of the supported AI/ML models is included in system information (SI) that is broadcast in a cell of the base station. The UE 3 in this example is in the RRC idle or RRC inactive state (but could alternatively be in the RRC connected state). Advantageously, therefore, the UE 3 is able to receive the information indicating which AI/ML models are supported by the base station 5, even when the UE 3 is in the RRC idle or RRC inactive state.

The broadcast SI may include a list of AI/ML model IDs and/or version numbers for the supported AI/ML models. The supported AI/ML models may be indicated per use case. For example, a first indication of the AI/ML models supported for beam management may be provided, and a second indication of the AI/ML models supported encoding/decoding CSI may also be provided. The indication of the supported AI/ML models may be broadcast periodically by the base station 5, or alternatively could be broadcast in an on-demand manner in response to a request from the UE 3. In addition, the broadcast SI may include an indication of a method for acquiring the AI/ML model (e.g., signaling-based transmission between the UE 3 and the RAN node 5, or data-based transmission between the UE 3 and an AI/ML server 151). In a case where the UE 3 is to acquire the AI/ML model from an AI/ML server 151, the identity and (IP) address of the AI/ML server 151 can also be included in the SI. Whilst in this example the indication of step S1401 is broadcast by the base station 5, the indication could alternatively be transmitted to the UE 3 in a multicast transmission.

In step S1402 the UE 3 determines, based on the indication of the supported AI/ML models received from the base station 5, whether to obtain one of the supported AI/ML models. In this example, the UE 3 determines to obtain one of the models, and transmits a request for the model to the base station 5 in step S1403. Step S1403 may be performed when the UE 3 is in the RRC idle or RRC inactive state (or, as described in more detail below, as part of a transition from the RRC idle or RRC inactive state to the RRC connected state, e.g. using MSG3). In step S1404 the base station 5 transmits the requested model to the UE 3. As described in more detail below, the UE 3 may be in the RRC connected, RRC inactive or RRC idle state when receiving the AI/ML model from the base station in step S1404.

Whilst in the example of FIG. 12 the UE 3 transmits the request for the AI/ML model to the base station 5, and receives the requested AI/ML model from the base station 5, this need not necessarily be the case. The UE 3 may alternatively request and receive the AI/ML model from any other suitable node in the network (e.g. another base station 5, or a core network node/function/server) after receiving an indication of the supported AI/ML models.

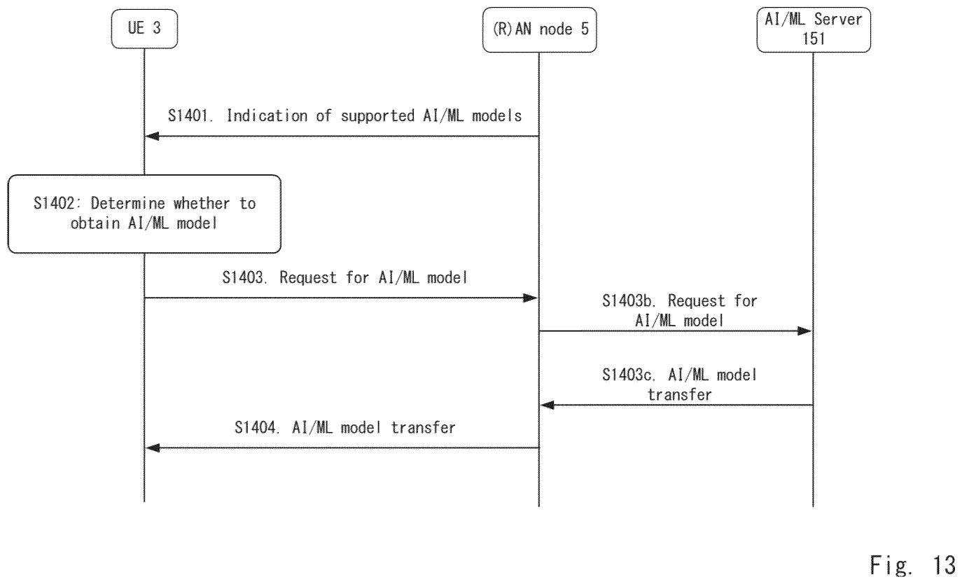

For example, FIG. 13 shows a modified version of FIG. 12 in which the UE 3 requests an AI/ML model that is stored at an AI/ML server 151. FIG. 13 includes new steps S1403b and S1403c. In step S1403b, the base station 5 transmits, to the AI/ML server 151, a request for the AI/ML model requested by the UE 3. In step S1403c, the AI/ML server 151 transmits the requested model to the base station 5, for forwarding to the UE 3 in step S1404. The forwarding of the AI/ML model via the base station 5 of steps S1403c and S1404 may be transparent to the base station 5 (e.g. the AI/ML model could be transmitted using one or more transparent containers). In a further alternative, the UE 3 may obtain the AI/ML model from the AI/ML server 151 via an AMF 10-1, for example using NAS based signaling. For example, rather than transmitting the request for the AI/ML model to the base station 5, the UE 3 could transmit the request for the AI/ML model to the AMF 10-1. The AMF 10-1 could then request the model from the AI/ML server 151, and forward the AI/ML model from the AI/ML server 151 to the UE 3. In another alternative, the UE 3 could request the AI/ML model from the base station 5, which could then request the AI/ML model from the AI/ML server 151. However, rather than transmitting the AI/ML model to the UE 3 via the base station that received the request, the AI/ML model could be transmitted to the UE 3 via the AMF 10-1 (using corresponding NAS signaling). Rather than transmitting the request for the AI/ML model to the base station 5, the UE 3 could alternatively transmit the request for the AI/ML model directly to the AI/ML server (e.g. if UE 3 has already obtained information indicating that the AI/ML model is stored at the AI/ML server 151).

When the UE 3 requests an AI/ML model that is stored at the AI/ML server 151, the UE's 3 acquisition of the AIML model from the AI/ML server 151 may be transparent to the radio network from a signaling perspective, since the AI/ML model transfer from the AI/ML server 151 to the UE 3 can be normal data transmission, or the like. However, when the UE 3 establishes an RRC connection with the radio network for such data transmission, it may include the RRC establishment cause (e.g., for AI/ML model transfer) and/or the AI/ML server address in the RRC message. The (R)AN node 5 may forward the information to the core network. Beneficially, the information helps the RAN node 5 and/or the core network node to establish the subsequent user plane data tunnel for AI/ML model transmission between the AI/ML server 151 and the UE 3.

The determination of whether to obtain an AI/ML model in step S1402 may be based on a comparison of an AI/ML model stored at the UE 3 and the supported AI/ML models. For example, the base station 5 may provide an indication of model versions of the supported AI/ML models in the information broadcast in step S1401, and the UE 3 may compare a version number of a model stored at the UE 3 to a version number of one of the supported models and determine that a newer version of a model is to be obtained. Alternatively, the UE 3 may determine that the UE 3 does not store an AI/ML model for a particular use case (e.g. for encoding CSI), and therefore determine to obtain the supported AI/ML model for that use case. Additionally, or alternatively, the UE 3 may determine to transmit the request for the AI/ML model based on a timer. The use of a timer UE 3 enables the UE 3 to request a more recent version of the AI/ML model, even if the UE 3 has not received the indication of the supported AI/ML models of step S1401 (for example, the UE 3 may transmit a request for the most recent version of an AI/ML model stored at the UE 3 to the base station 5 based on the timer, irrespective of whether the UE 3 has received the transmission of step S1401). In a further alternative, the base station 5 may determine to transmit an updated version of a model to the UE 3 in step S1404 based on a timer. Therefore, the base station 5 is able to provide the UE 3 with a more recent version of the AI/ML model even if the base station 5 has not received a request for the more recent version of the AI/ML model from the UE 3. This can be particularly beneficial for two-sided models, for which the version of the model at the UE 3 (e.g. for encoding CSI) may need to match, or correspond to, the version of a model at the base station 5 (e.g. for decoding CSI).

By transmitting the request for the AI/ML model in step S1403 or the transfer of the model in step S1404 based on a timer, the risk of the model at the UE 3 becoming mismatched with the model at the base station 5 is reduced. It will be appreciated that even when a timer is used for the transmission of S1403, the UE 3 may nevertheless determine to transmit a request for one or more AI/ML modes even if the time has not yet expired (e.g. based on the information received in step S1401, as described above).

The UE 3 may perform a random access procedure to request the AI/ML model from the base station 5 (e.g. the RA procedure described above with reference to FIG. 6). In this example, MSG3 transmitted from the UE 3 to the base station 5 in the RA procedure includes an RRC establishment cause that indicates that the UE 3 is requesting an AI/ML model (e.g. by including an indication of the identity of the requested AI/ML model, or an indication that the UE 3 is to enter the RRC connected state to download an AI/ML model from the base station 5). The UE 3 may use the RA procedure to request the AI/ML model in both the example of FIG. 12 in which the requested AI/ML model is initially stored at the base station 5, or in the method of FIG. 13 in which the AI/ML model is initially stored at the AI/ML server 151 (or any other suitable network node).

Whilst the use of MSG3 and the RRC establishment cause provides an efficient mechanism for indicating that the UE 3 is requesting an AI/ML model, the indication could alternatively be provided in any other suitable transmission from the UE 3 to the base station 5. For example, the UE 3 may use an RRC message (e.g. dedicated RRC message) to indicate that the UE 3 is requesting an AI/ML model. Any other suitable method of obtaining the AI/ML model could alternatively be used—the UE 3 need not necessarily use the RA procedure to obtain the model.

In a further alternative, rather than the UE 3 requesting the AI/ML model (entering the RRC connected state to receive the model) in response to the determination of step S1402, the UE 3 may simply wait until the UE 3 is next in the RRC connected state before obtaining the AI/ML model from the base station 5. In another alternative, the UE 3 may receive the AI/ML model when the UE 3 is in the RRC idle or RRC inactive state, rather than entering the RRC connected state to receive the AI/ML model. In this case, the base station 5 transmits an indication of the communication resources (e.g. time and frequency resources) for use by the UE 3 to receive the AI/ML model whilst the UE 3 is in the RRC idle or RRC inactive state.

The AI/ML model may be transmitted from the base station 5 to the UE 3 in step S1404 using an RRC message or a user plane transmission (e.g. using a data radio bearer (DRB)). Advantageously, a priority (e.g. transmission priority) can be assigned for the DRB or logical channel that carries the AI/ML model. As described above, a logical channel may be assigned (e.g. by the base station 5) an index that indicates a priority for transmission of the logical channel, and/or a prioritized bit rate (PBR). The priority or PBR configured for the DRB or LCH that carries the AI/ML model may depend, for example, on the type of AI/ML model that is requested (e.g. the use case of the AI/ML). For example, the DRB or LCH used to transmit an AI/ML model for use as part of a handover procedure could be assigned a higher priority (or higher PBR) than if the AI/ML model were for use in a beam prediction procedure.

From an air interface perspective, when AIML model transfer is subject to user plane transmission as described above, it may be different from conventional user plane (UP) transmission. Conventional UP transmission requires two, or multiple, portions-based transmission (an air interface plus backhaul-based fixed network), e.g. DRB over the air interface plus a data tunnel established between the base station 5 and a UPF in the core network that bridges the data towards a data server. In this conventional method of UP transmission, the base station 5 is not the producer of the data, and instead it is a ‘consumer’ of the data, since the base station simply converts one or more QoS flows into DRB at the SDAP layer, to support the data transmission for a particular Qos service in terms of data radio bearer over air interface. However, this traditional UP transmission can advantageously be modified: the base station 5 can be the data producer, in a case where the base station 5 itself holds the AIML model, ready for transfer to the UE. When the base station 5 determines to transfer the AI/ML model to the UE 3 via a UP based channel, the base station 5 can configure the data content of AI/ML model as a Service Data Unit (SDU) to the PDCP layer, which can be viewed as a special Data Radio Bearer. In this case, the data of the AI/ML model will not be carried by the SDAP layer, in contrast to the conventional method.

Step S1404 of FIGS. 12 and 13 may comprise transmitting the AI/ML model to the UE 3 using a dedicated radio bearer (e.g. a bearer other than a legacy SRB/DRB). A logical channel (e.g. dedicated logical channel) could be used to transmit the AI/ML model. The logical channel could be assigned a priority and/or PBR as described above, or alternatively the logical channel may simply not be multiplexed with other logical channels and instead could be transmitted separately.

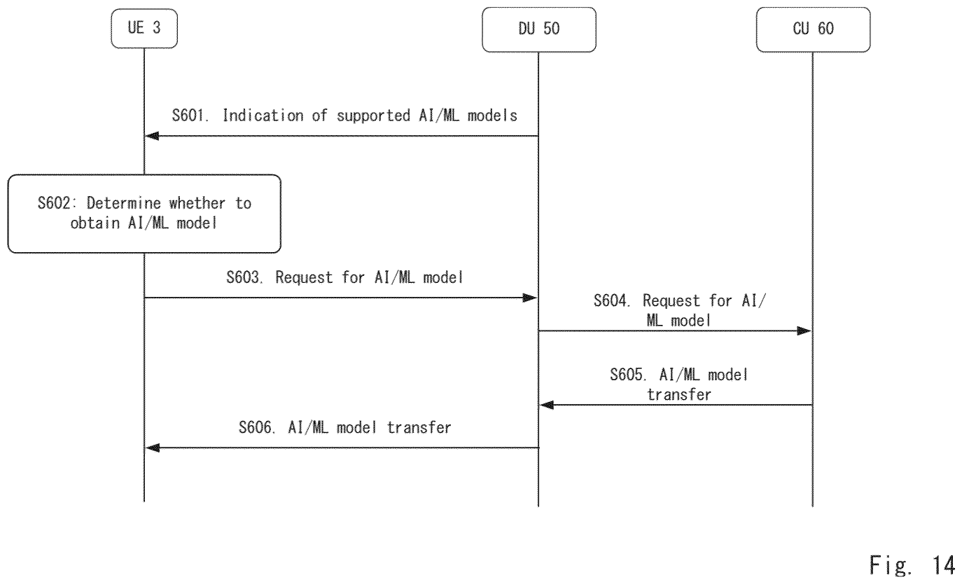

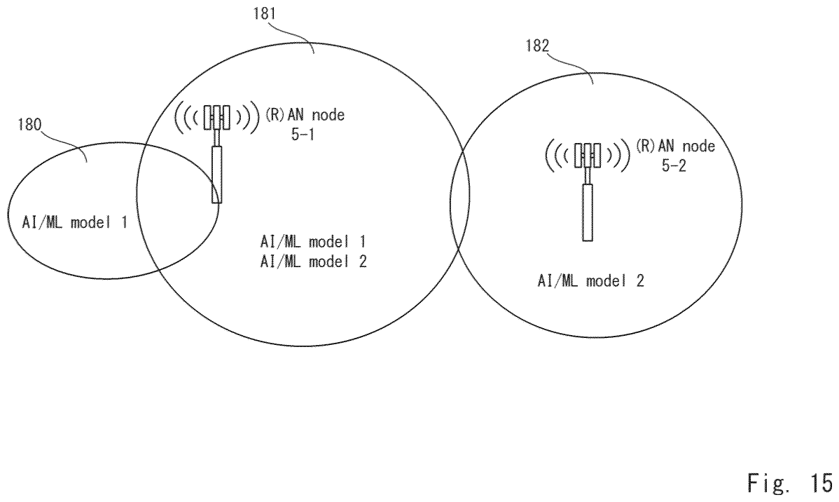

FIG. 14 shows an example of how the requested AI/ML model can be obtained by the UE 3 when the requested AI/ML model is initially stored at a CU 60 of a distributed base station. Steps S601 to S603 are the same as steps S1401 to S1403 described above, and so will not be described again here. In step S604 the DU 50 transmits a request for the AI/ML model requested by the UE 3 to the CU 60, and in step S605 the CU 60 transmits the AI/ML model to the DU 50. Step S606, in which the DU 50 transmits the requested AI/ML model to the UE 3, is the same as step S1404 of FIGS. 14 and 15.

A dedicated F1-application protocol (AP) message or procedure can be used to transmit the AI/ML model from the CU 60 to the DU 50 in step S605. Moreover, The CU 60 could also transmit, to the DU 50, an indication of the supported AI/ML models to be broadcast by the DU 50 in step S601. The indication of the supported AI/ML models (e.g. model IDs) could be transmitted from the CU 60 to the DU 50 using an F1-AP message (e.g. a dedicated F1-AP message). The DU 50 is therefore able to determine the indication of the supported AI/ML models to be broadcast in step S601.

As described above, the indication of the supported AI/ML models may be transmitted in step S1401 (or step S601) using system information broadcast in a cell of the base station 5. A SIB could be used to transmit the indication of the supported AI/ML models. This SIB may be referred to as an ‘AI/ML SIB’. SIB1 could be used to provide an indication that the AI/ML SIB is available for broadcast in the cell (the AI/ML SIB may be on-demand SI, that is transmitted in response to a request from the UE 3 that is not shown in FIG. 12 but is transmitted by the UE 3 before step S1401). The MIB and SIB1 may provide the UE 3 with an indication of scheduling information for receiving and decoding the dedicated AI/ML SIB. The AI/ML SIB may include the model IDs of the supported (or ‘available’) AI/ML models. As described above, the AI/ML SIB may indicate the supported AI/ML mods per use case.

The AI/ML SIB may be broadcast periodically (e.g. according to a predetermined periodic pattern), or alternatively may be provided ‘on-demand’, for example in response to the request from a UE 3. SIB1 can be used to indicate to the UE 3 whether the AI/ML SIB is transmitted periodically or whether it is available on-demand.

When the AI/ML SIB is available in an on-demand manner, the base station 5 provides an indication of the availability of the AI/ML SIB, or information indicating the supported AI/ML model IDs for a particular feature (e.g., beam management) in the system information SIB1. The UE 3 may be configured to request the AI/ML SIB using message 1 (MSG1), which may be referred to as a MSG1-based on-demand SI request for the AI/ML SIB, or message 3 (MSG3), which may be referred to as a MSG3-based on-demand SI request for the AI/ML SIB. The UE 3 may also use another type of uplink message to indicate that the UE 3 is requesting information regarding one or more AI/ML models supported by the base station (e.g., AI/ML model IDs). When the network receives the UE's 3 request for the information (e.g., AI/ML IDs), the network broadcasts the supported AI/ML information (e.g. AI/ML model IDs) for one or more features as requested by the UE 3 (e.g. using a system information block, AI/ML SIB). The UE 3 can then acquire the AI/ML information by receiving and decoding the broadcasted message (e.g. the AI/ML SIB).

In the examples described above with reference to FIGS. 12 to 14, the UE 3 may request a single AI/ML model, or alternatively could request a plurality of AI/ML models in step S1403 (or step S603).

### (Area/Location-Based AI/ML Models)

Methods related to area-based or location-based AI/ML models will now be described. An AI/ML model may be for use in a particular area or location. An AI/ML model may be for use in a particular cell or group of cells, which may be operated by one or multiple base stations 5. For example, an AI/ML model may be for use in a group of cells for beam management.

The area in which an AI/ML model is to be used may comprise one or more cells, one or more RAN-based notification areas (RNAs), or registration areas (RAs). However, it will be appreciated that any other suitable area for use of the AI/ML model could be defined. The area within which the AI/ML model is to be used for a particular function (e.g. beam management, CSI encoding/decoding, or mobility) may be referred to as an AI/ML model function area.

A cell provided by a base station 5 may be part of a plurality of AI/ML model function areas. FIG. 15 shows an example in which a first base station 5-1 provides a first cell 180 and a second cell 181, and a second base station 5-2 provides a third cell 181. In this example, a first AI/ML model is for use in the first cell 180 and the second cell 181 for a first function (e.g. beam management). The AI/ML model function area of the first AI/ML model therefore comprises the first cell 180 and the second cell 181. A second AI/ML model is for use in the second cell 181 and the third cell 182 for a second function (e.g. for CSI encoding/decoding). The AI/ML model function area of the second AI/ML model therefore comprises the second cell 181 and the third cell 182.

In this example, the second cell 181 belongs to both the AI/ML model function area of the first AI/ML model and the AI/ML model function area of the second AI/ML model. In this example, one AI/ML model is used for use for each function in each area. Alternatively, more than one AI/ML model may be available for use for a function in a particular area (e.g. more than one AI/ML model may be available for UE mobility inferences in a particular cell).

In this example, the base station 5-1 is configured to transmit a broadcast transmission in the first cell 180 that indicates that the first cell 180 belongs to the AI/ML model function area of the first AI/ML model, and to transmit a broadcast transmission in the second cell 181 that indicates that the second cell belongs to the both the AI/ML model function area of the first AI/ML model and the AI/ML model function area of the second AI/ML model. The indication of which AI/ML model function areas the cell belongs to may be referred to as AI/ML model area information. Therefore, a UE 3 in a cell of the base station 5-1 is able to determine which AI/ML model to use for a particular function in that cell.

The base station 5 may be configured to indicate, in the broadcast transmission, the model function areas to which the cell belongs per AI/ML model, or per function. For example, the base station 5 may support two AI/ML features/functions, with AI/ML model X used for the first function, and AI/ML model Y used for the second function. From a network deployment perspective, AI/ML model X for the first function can belong to Area N (which could be, for example, a relatively small area), and AI/ML model Y for the second feature could belong to Area M (which could be, for example, a relatively large area). The broadcast information could indicate that the cell supports AI/ML models X and Y, could indicate that the cell supports the first function with AI/ML model X and the second function with AI/ML model Y, or alternatively could indicate that the cell is part of the corresponding areas N and M (for different models or functions).

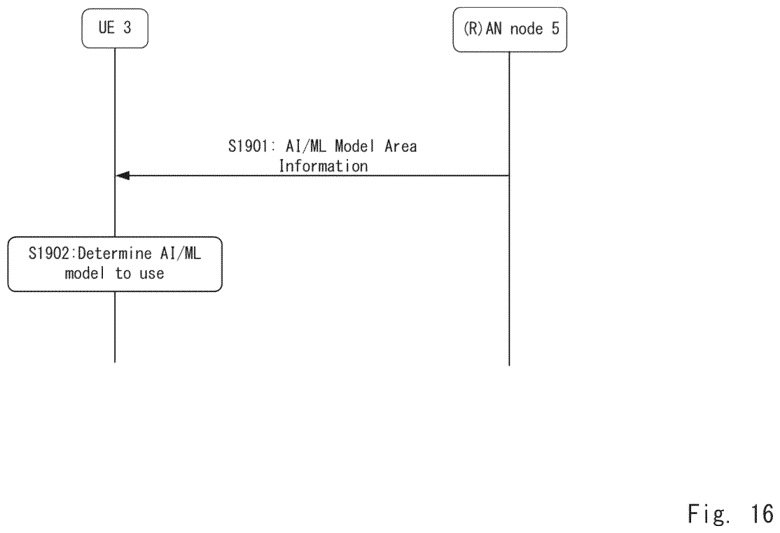

FIG. 16 illustrates a method in which the AI/ML model area information is received by a UE 3. In step S1901 the base station 5 transmits (broadcasts) the AI/ML model area information in a cell of the base station 5, and the information is received by a UE 3 in the cell.

In step S1902 the UE 3 determines, based on the AI/ML model area information, to use a particular AI/ML model. For example, when the UE 3 is in the second cell 181 of FIG. 15 and receives AI/ML model area information that the first AI/ML model is for use for the first function in the second cell 181, the UE 3 determines to use the first AI/ML model for the first function in the second cell 181. If the UE 3 does not support an AI/ML model indicated in the AI/ML model area information, then the UE 3 may simply ignore the AI/ML model area information. After the UE 3 determines to use a particular AI/ML model, the UE 3 may obtain the AI/ML model (if it is not already stored at the UE 3) according to any of the methods described herein (e.g. any of the methods illustrated in FIGS. 12 to 14). For example, the UE 3 may use a random access procedure including MSG3 as part of a method for obtaining the AI/ML model, as described above. As described above, the UE 3 may obtain the AI/ML model either directly from the base station 5, or from another node in the network (e.g. from an AI/ML server 151 (via an AMF 10-1), from an operations, administration, and maintenance server (OAM), or from any other suitable node/function in the network).

Alternatively, rather than the AI/ML model area information including an indication of which AI/ML model is supported for a particular function, the AI/ML model area information may simply include an indication that a particular function is supported in the area. In this case, after receiving the AI/ML model area information, the UE 3 may determine to obtain system information broadcast in the cell to determine which AI/ML model to use. For example, as described above, the UE 3 may request an on-demand SIB that includes an indication of the AI/ML models that are supported for particular functions in the cell. The UE 3 may determine to obtain the AI/ML model after moving into a new cell and receiving the broadcast transmission of step S1901 (e.g. following a cell reselection procedure), or if the AI/ML for use for a particular function in the cell is changed (which the UE 3 can also identify based on the broadcast transmission of step S1901). The UE 3 may be configured to periodically check for transmission of the AI/ML model area information by the base station 5 (e.g. by receiving and decoding the corresponding SI) based on a timer. Similarly, the base station 5 may be configured to periodically broadcast the AI/ML model area information in one or more cells based on a timer.

If the AI/ML model supported for use for a function in a particular area is updated, then the UE 3 may obtain the updated model using any of the methods described above (e.g. the method described with reference to FIG. 14).

The UE 3 may store a plurality of AI/ML models that could be used for a particular function, and the UE 3 may select one of the plurality of AI/ML models based on the AI/ML model area information received in step S1901. For example, the UE 3 may store a first AI/ML model for beam management in a first area, and a second AI/ML model for beam management in a second area, and may determine to use the first AI/ML model based on an indication, in the AI/ML model area information, that the cell belongs to the first area. If the cell belongs to both the first area and the second area, then the UE 3 may provide an indication to the network (e.g. to the base station 5) of whether the first AI/ML model or the second AI/ML model is to be used (e.g. which model is preferred by the UE 3). Advantageously, therefore, for two-sided models a mismatch between the model used at the base station 5 and the model used at the UE 3 can be avoided when a plurality of models are supported for the same function in a particular area. The UE 3 may provide an indication of which AI/ML model is to be used (or which AI/ML is preferred for use) using the first RRC message transmitted to the base station 5 after the UE 3. The UE 3 may include the indication in MSG3 described above with reference to FIG. 6.

In the example of FIG. 15, mobility of the UE 3 may occur from the second cell 181 to the third cell 182. Whilst in the second cell 181, the UE 3 uses the first AI/ML model for the first function. However, in this example the third cell 182 does not support the first function. Therefore, the UE 3 may determine not to use (or to disable) the first AI/ML model for the first function after the UE 3 has moved into the second cell 5-2. For example, the UE 3 may determine to not use (or to disable) the first AI/ML model in response to receiving a broadcast transmission from the second base station 5-2 that indicates the AI/ML models supported in the third cell 182 (or the AI/ML model function areas to which the third cell 182 belongs). The UE 3 may also determine not to use (or to disable) the first AI/ML model in the third cell 182 even if the UE 3 has not received the broadcast transmission from the second base station 5-2. For example, the UE 3 may determine not to use (or to disable) the first AI/ML model in the third cell 182 as a default option, and only determine to use the first AI/ML model in the third cell if the UE 3 receives an indication that the first AI/ML model can be used in the third cell 182). Advantageously, therefore, use of an unsupported AI/L model or AI/ML model function can be avoided, even when the base station 5-2 is a legacy base station that may not support transmission of AI/ML related information.

### (UE Mobility and AI/ML Models)

As described above with reference to FIG. 5, the UE 3 may be handed over from a source base station 5 to a target base station in a handover procedure 5. Improved methods for transmitting AI/ML models and/or AI/ML model related information between the base stations 5, and between the base stations 5 and the UE 3, will now be described.

The UE 3 is initially connected to the source base station 5-1 and is configured to use an AI/ML model. For example, the UE 3 may be using an AI/ML model for: energy saving; traffic steering; anomaly detection; QoE optimization; or any other suitable AI/ML model. The AI/ML model may be a ‘two-sided’ model, in which an AI/ML model is hosted at the UE 3, and a corresponding AI/ML model is hosted at the base station 5. Alternatively, the AI/ML model may be a ‘single-sided’ model that is used at the UE 3 only. The UE 3 may have obtained the AI/ML model using, for example, any of the methods described above with reference to FIGS. 12 to 14.

Following handover to the target base station 5-2, the UE 3 may continue to use the same AI/ML model for a particular feature that the UE 3 was using before the handover. Alternatively, the UE 3 may switch to using a different AI/ML model for the feature after the UE 3 has been handed over to the target base station 5-2. For example, the source base station 5-1 and the target base station 5-2 may be operated by different vendors, and the two base stations 5-1, 5-2 may use a different AI/ML model for a particular feature.

In a further alternative, use of an AI/ML model for a particular feature or use case may not be supported after the UE 3 has been handed over to the target base station 5-2, for example because the target base station 5-2 does not support use of AI/ML models, in which case the UE 3 might not use an AI/ML model for the feature at all.

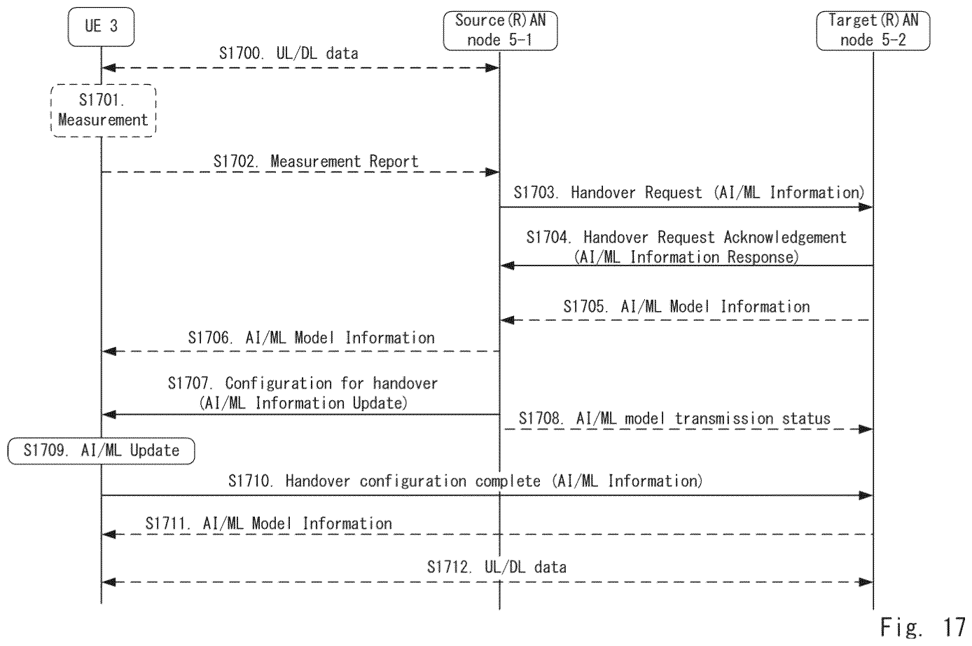

FIG. 17 shows a modified version of FIG. 5, in which various steps of the method have been modified to include transmission of an AI/ML model and/or AI/ML model related information.

In step S1700 the UE 3 is connected to the source base station 5-1. The UE 3 may transmit UL data to the source base station 5-1, and may receive downlink data from the source base station 5-1.

Steps S1701 and S1702 are the same as steps S501 and S502 of FIG. 5 and so will not be described again here. In this example, after receiving the measurement report from the UE 3 in step S1702, the source base station 5-1 determines that the UE 3 is to be handed over to the target base station 5-2. However, it will be appreciated that the source base station 5-1 may determine that the UE 3 is to be handed over to the target base station 5-2 in any other suitable manner, without necessarily receiving the measurement report of step S1702. For example, the source base station 5-1 may determine to hand over the UE 3 to the target base station 5-2 to reduce an RRC communication load at the source base station 5-2, or based on a mobility of the UE 3 (e.g. predicted path of the UE 3) predicted using an AI/ML model.

In step S1703 the source base station 5-1 transmits a handover request to the target base station 5-1. The handover request includes AI/ML information. The AI/ML information may include an indication of the identity of AI/ML models supported for use at the source base station. The indication of the identity of AI/ML models may be provided per feature or use case, which may be described by a ‘function identity’. For example, the AI/ML model information may provide an indication that one or more AI/ML models are supported for UE mobility predictions, and an indication that one or more AI/ML models are supported for anomaly detection (or for any other suitable function or use case, such as encoding/decoding of CSI for transmission/reception of a CSI feedback report, beam management methods, or UE position enhancement methods). The AI/ML information may include an indication of a version number for the supported AI/ML models. It will be appreciated that the version number need not necessarily be the same number as the AI/ML model ID number.

The AI/ML information transmitted in step S1703 may comprise an indication of one or more AI/ML model function areas to which the cell of the source base station, via which the UE 3 communicates with the source base station 5-1 before the handover, belongs. AI/ML model function areas have been described above with reference to FIG. 15.

The AI/ML information transmitted in step S1703 may comprise an indication of one or more AI/ML models currently selected (e.g. by the UE 3 or the source base station 5-1) for use by the UE 3 (or for use by the source base station 5-1, or for use by the UE 3 and the source base station 5-1). The source base station 5-1 may support a plurality of AI/ML models for a particular feature, and the source base station 5-1 may transmit an indication of the AI/ML model of the plurality of AI/ML models that is currently used for the feature.

The target base station 5-2 receives the AI/ML information transmitted in step S1703 and is advantageously able to determine one or more AI/ML models for use after the UE 3 is handed over to the target base station 5-2.

Whilst the AI/ML information is illustrated in FIG. 17 as being transmitted as part of the handover request, this need not necessarily be the case. For example, the AI/ML information could be transmitted in a separate transmission between the source base station 5-1 and the target base station 5-2 between steps S1702 and S1703, or between steps S1703 and S1704. An Xn message, for example a dedicated Xn message carrying AIML information element (IE), could be used to transmit the AI/ML information to the target base station 5-2 via an Xn interface between the source base station 5-1 and the target base station 5-2. The AI/ML information could alternatively be transmitted to the target base station 5-2 using an RRC container within the handover request message of step S1703.

In step S1704 the target base station 5-2 transmits a handover request acknowledgement to the source base station 5-1. The handover request acknowledgement may also be referred to as a “handover acknowledgement”. The handover request acknowledgement comprises an AI/ML information response. The AI/ML information response may include an indication of one or more AI/ML models supported for use at the target base station 5-2. For example, the AI/ML information may include the AI/ML model IDs or version numbers of the AI/ML models that are supported for use (e.g. per feature or use case, which may be described by a ‘function identity’) at the target base station 5-2.

For example, the AI/ML information transmitted in step S1703 may comprise an indication of one or more AI/ML models supported by the source base station 5-1 for a particular feature, and the AI/ML information response of step S1704 may comprise an indication of which of those AI/ML models are also supported by the target base station 5-2. Advantageously, therefore, the source base station is able to determine, based on the AI/ML information response, which of the AI/ML models are supported for the UE 3 by both the source base station 5-1 and the target base station 5-2 (which can be used by the source base station 5-1 to improve the continuity of the AI/ML model usage during and after the handover procedure). The AI/ML information response may also include an indication of one or more additional AI/ML models that are supported at the target base station 5-2 but are not supported at the source base station 5-1 (e.g. per feature or use case).

If the AI/ML information transmitted in step S1703 does not comprise an indication of one or more AI/ML models supported by the source base station 5-1, or if there is no AI/ML information transmitted from source base station 5-1 to the target base station 5-2 in step S1703, the target base station 5-2 may nevertheless transmit an indication of the AI/ML models supported by the target base station 5-2 in step S1704 (e.g. per feature or use case).

Rather than transmitting an indication of the specific supported AI/ML models in step S1704 (e.g. by transmitting corresponding AI/ML model IDs or version numbers), the target base station 5-2 may simply transmit, in step S1704, an indication of the AI/ML model use cases or features that are supported. For example, the AI/ML information response may include an indication that the target base station 5-2 supports use of AI/ML models for UE 3 mobility predictions, or that the target base station 5-2 supports use of AI/ML models for anomaly detection (or any other suitable use case/feature).

Similarly, the AI/ML information received from the source base station 5-1 in step S1703 may comprise an indication of the AI/ML model use cases or features that are supported at the source base station 5-1 (rather than an indication of the specific AI/ML models that are supported). In this case, the target base station 5-2 may transmit, in step S1704, an indication of the AI/ML models that are supported at the target base station 5-2 for one or more features/use cases indicated in the AI/ML information of step S1703.

The target base station 5-2 may also include, in the AI/ML information response of step S1704, an indication of one or more AI/ML model function areas to which the cell of the target base station belongs. The AI/ML model function areas may be indicated per AI/ML model or use case in the AI/ML information response.

The target base station 5-2 may include a version number for an AI/ML model that is supported at the target base station 5-2 in the AI/ML information response if a different version of the AI/ML model is supported at the source base station 5-1. For example, the AI/ML information received in step S1703 may include an indication that a first version of an AI/ML model is supported at the source base station 5-1. The target base station 5-2 may determine, in a case where the target base station 5-2 supports a second version of the AI/ML model but not the first version, to transmit an indication to the source base station 5-1 that the target base station supports the second version of the AI/ML model (e.g. by transmitting the version number of the second version of the model). In a case where the target base station 5-2 supports the first version of the model, the target base station 5-2 could transmit an indication (e.g. using a one-bit field) that the AI/ML model is supported, without necessarily transmitting an indication of a version number of the model to the source base station 5-1. Alternatively, the target base station 5-2 may simply always transmit an indication of the version number of the supported AI/ML model to the source base station in step S1704.

The AI/ML information response may include an indication of one or more AI/ML models (or a particular version of an AI/ML model) for use by the UE 3 during or after the handover. The one or more AI/ML models for use by the UE 3 could be indicated per feature or use case. An AI/ML model indicated for use by the UE 3 during or after the handover may be the same as a model already in use by the UE 3 before the handover, or could be a different AI/ML model (e.g. an AI/ML model that is supported at the target base station 5-2 but is not supported at the source base station 5-1).

Whilst the AI/ML information response of step S1704 is illustrated in FIG. 17 as being transmitted as part of the handover request acknowledgement, this need not necessarily be the case. For example, the AI/ML information response could be transmitted in a separate transmission from the target base station 5-2 to the source base station 5-1 between steps S1703 and S1704, or between steps S1704 and S1705. An Xn message, for example a dedicated Xn message that includes an AIML information element (IE), could be used to transmit the AI/ML information response to the source base station 5-1 via an Xn interface between the target base station 5-2 and the source base station 5-1. The AI/ML information response could alternatively be transmitted to the source base station 5-1 using an RRC container within the handover request acknowledgement message of step S1704.

The source base station 5-1 station is advantageously able to determine, based on the AI/ML information response received from the target base station 5-2 in step S1704, one or more AI/ML models (or one or more versions of AI/ML models) for use by the UE 3 after the handover of the UE 3 from the source base station 5-1 to the target base station 5-2. For example, when the AI/ML information response includes an indication of one or more models supported by the target base station 5-2 for a particular feature, the source base station 5-1 may compare the AI/ML models available at the source base station 5-1 (or at the UE 3) to the AI/ML models supported by the target base station 5-2, and determine that the UE 3 is to use an AI/ML model that is both available at the source base station 5-1 (or at the UE 3) and supported at the target base station 5-2. Alternatively, the source base station 5-1 (or the target base station 5-2) may determine that the UE 3 is to use an AI/ML model that is supported at the target base station 5-2 but is not currently available at the source base station 5-1 or the UE 3 (or a version of an AI/ML model that is supported by the target base station 5-2 but is not available at the source base station 5-1 or the UE 3). In this case, the AI/ML model for use after the handover to the target base station 5-2 can be transmitted to the UE 3, either by the source base station 5-1, the target base station 5-2, or another entity in the network.

In optional step S1705 the target base station 5-2 transmits AI/ML model information to the source base station 5-1. The AI/ML model information includes information for obtaining an AI/ML model that is supported at the target base station 5-2. The AI/ML model information may comprise the AI/ML model itself, or may provide an indication of how the AI/ML model can be obtained (e.g. by providing a network address of a network entity or network server from which the AI/ML model can be obtained, such as an over-the-top (OTT) server or core network node/function that stores the AI/ML model).

In a case where the AI/ML model is transmitted from the target base station 5-2 to the source base station 5-1 in step S1705, the source base station 5-1 may transmit the AI/ML model to the UE 3 in optional step S1706. The AI/ML model may be transmitted to the UE 3 from the source base station 5-1 using any suitable transmission. For example, the AI/ML model may be transmitted from the source base station 5-1 to the UE using an RRC message or a user plane transmission (e.g. using a data radio bearer (DRB)). The AI/ML model may be transmitted to the UE 3 using a dedicated radio bearer (e.g. a bearer other than a legacy SRB/DRB). A logical channel (e.g. dedicated logical channel) could be used to transmit the AI/ML model. The logical channel could be assigned a priority and/or PBR as described above, or alternatively the logical channel may simply not be multiplexed with other logical channels and instead could be transmitted separately. The source base station 5-1 may encapsulate the AI/ML model for transmission to the UE 3 in the configuration for handover message of step S1707 of FIG. 17, which may be an RRC reconfiguration message, in which case the separate transmission of step S1706 need not necessarily be performed.

If the AI/ML model information provided in either step S1704 or step S1705 includes information for obtaining an AI/ML model (e.g. from an entity in the network other than the target base station 5-2), rather than the AI/ML model itself, then the source base station 5-1 may obtain the AI/ML model before transmitting the AI/ML model to the UE 3 (e.g. by requesting the model from another entity in the network, such as an AI/ML server 151 as illustrated in FIG. 13). Forwarding of the AI/ML model from an AI/ML server 151 to the UE 3 via the source base station 5-1 may be transparent to the source base station 5-1 (e.g. the AI/ML model could be transmitted using one or more transparent containers). Alternatively, the source base station 5-1 may forward the information for obtaining an AI/ML model to the UE 3, and the UE 3 may use the information for obtaining an AI/ML model to obtain the model (e.g. by requesting the model from the target base station 5-2 either before, during or after the handover procedure, or from another entity in the network).

Rather than transmitting the information for obtaining the AI/ML model in step S1705, the information for obtaining the AI/ML model could alternatively be transmitted in the handover request acknowledgement message of step S1704. The transmission of step S1704 may include an explicit or implicit request for the source base station 5-1 to transmit one or more AI/ML models to the UE 3. For example, the AI/ML information response of step S1704 may comprise a list of AI/ML models to be transmitted to the UE 3 (e.g. AI/ML model ID numbers, version numbers, and/or function identities). The handover request acknowledgement message may include an indication of an AI/ML model to be transmitted to the UE 3 per feature or use case. The source base station 5-1 then transmits the one or more AI/ML models to the UE 3 in step S1706 (without step S1705 necessarily being performed).

If the AI/ML model for use by the UE 3 after the handover to the target base station 5-2 is available at the UE 3 before, or during, the handover process, then the UE 3 may begin using the AI/ML model before the handover is complete. For example, if the UE 3 is already using the AI/ML model (or the AI/ML model is activated for use at the UE 3) before the handover, then the source base station 5-1 may transmit an indication to the UE 3 that the UE 3 is to continue to use the AI/ML model (or the AI/ML model is to continue to remain activated) after the handover is complete (the indication could be provided, for example, in the transmissions of step S1706 or S1707). The indication that the UE 3 is to continue to use the AI/ML model may comprise the AI/ML model ID number or version number for use for a particular feature (for example, identified by a specific function ID), or could alternatively be an indication of the feature or use case (for example, identified by a specific function ID) that the UE 3 is to continue to use the same AI/ML model for, after (and possibly during) the handover.

The configuration for the handover transmitted in step S1707 may be included in an RRC reconfiguration message. The RRC reconfiguration message may include, based on the information received in step S1704 or S1705, AI/ML model information (e.g. AI/ML model IDs or version numbers) for the AI/ML model use cases or features supported at the target base station 5-2. If the target base station 5-2 includes an indication of a preferred model for use by the UE 3 after the handover to the target base station 5-2 in the transmission of step S1704 or S1705, then the source base station 5-1 may transmit an indication of the preferred model to the UE 3 in step S1707 (or could alternatively transmit the indication in step S1706). An indication of the preferred model may be provided per AI/ML use case or function/feature. If the target base station 5-2 transmits an indication to the source base station 5-1, in step S1704 or S1705, that the target base station does not support a particular AI/ML model (which may be an explicit indication, or an implicit indication such as the AI/ML model not being included in a list of models transmitted to the source base station 5-1), then the source base station 5-1 may transmit, to the UE 3 (in step S1706 or S1707), an indication that the model that is not supported by the target base station 5-2 is not to be used by the UE 3 after the handover. The source base station 5-1 may transmit, in step S1706 or S1707, an indication that the AI/ML model that is not supported at the target base station 5-2 is to be disabled or deactivated at the UE 3.

Following step S1709, the UE 3 performs an AI/ML update. For example, the UE 3 may deactivate an AI/ML model, or activate an AI/ML model for use, based on the information received from the source base station 5-1 in step S1706 or S1707. If the UE 3 is already using an AI/ML model that is supported at the target base station 5-2 for a particular feature, then the UE 3 may simply continue to use that AI/ML model. If the UE 3 received an AI/ML model from the source base station in step S1706, then step S1709 may comprise preparing the model for use. For example, the UE 3 may configure one or more parameters of the received AI/ML model, so that the AI/ML model is ready for use after (and possibly during) the handover of the UE 3 to the target base station 5-2.

In step S1710, the UE 3 transmits an indication that configuration for the handover to the target base station 5-2 is complete. The transmission of step S1710 may be, for example, an RRC Reconfiguration Complete message. The UE 3 may include an indication of a preferred AI/ML model (or preferred AI/ML model version) for a particular feature in the transmission of step S1711. For example, the UE 3 and the target base station 5-2 may both support a plurality of AI/ML models (or AI/ML model versions) for a particular feature, and the UE 3 may indicate a preferred model or model version (for example, based on a memory or processing resources available at the UE 3, or based on a prediction accuracy of the model). If the UE 3 indicates a preferred AI/ML model, or in other cases in which a plurality of AI/ML models or model versions are supported by the UE 3 and the target base station 5-2, the target base station may transmit an indication of the AI/ML model (or model version) to be used to the UE 3 in step S1711 (or alternatively in any other suitable transmission).

If an AI/ML model for use by the UE 3 after the handover was not received from the source base station 5-1 and is not available at the UE 3, the UE 3 may receive the AI/ML model from the target base station 5-2 in step S1711.

In step S1712 the handover of the UE 3 from the source base station 5-1 to the target base station 5-2 has been completed. Uplink data can be transmitted from the UE 3 to the target base station 5-2, and downlink data ca be received by the UE 3 from the target base station 5-3.

Due to the relatively large amount of data that is transmitted when transmitting the AI/ML model to the UE 3, time required to transmit the AI/ML model to the UE 3 is relatively long. Therefore, there is an increased risk that when the AI/ML model is transmitted from the source base station 5-1 to the UE 3, handover of the UE 3 to the target base station 5-2 may be completed before the transmission of the AI/ML model from the source base station 5-1 to the UE 3 is complete.

In a case where transmission of the AI/ML model to the UE 3 is interrupted by the handover of the UE 3 from a source base station 5-1 to a target base station 5-2, the UE 3 may be configured to discard the segments (or other unit of received data) of the AI/ML model received from the source base station 5-1, and transmission of the model (from the target base station 5-2 to the UE 3) is restarted after the handover to the target base station 5-2 is complete.

Alternatively, the source base station may indicate (e.g. in step S1707 of FIG. 17) to the UE 3 that transmission of the AI/ML model is to be resumed following the handover. Following, or during, the handover the UE 3 may provide an indication to the target base station 5-2 of the status of the transmission of the AI/ML model (for example, by providing an indication in the handover configuration complete message of step S1710 of FIG. 17). For example, the UE 3 may transmit an indication of the number of segments (or any other suitable unit of data) of the AI/ML model received at the UE 3, an indication of the last segment received at the UE 3, or any other suitable information, to the target base station 5-2 in step S1710.

In the example of FIG. 17, the source base station 5-1 stores an indication of the number of segments (or any other suitable unit of data) of the AI/ML model transmitted to the UE 3, or an indication of the last segment transmitted to the UE 3 (e.g. in RRC context information), transmits the information to the target base station 5-2 (e.g. via an Xn interface) in optional step S1708. The source base station 5-1 may transmit, to the target base station 5-2, information indicating the identity of the AI/ML model that was being transmitted. The source base station 5-1 may also transmit, to the target base station 5-2, the remaining portion of the AI/ML model to be transmitted to the UE 3, or indication of the remaining portion (e.g. a segment number of the last segment of the AI/ML model transmission that was successfully transmitted to the UE 3, or a segment number of the next segment to be transmitted to the UE 3). The target base station 5-2 may then transmit the remaining portion of the AI/ML model to the UE 3 (for example, in optional step S1711 of FIG. 17). Advantageously, therefore, the remaining portion of the AI/ML model can be transmitted from the target base station 5-2 to the UE 3, rather than the entire AI/ML model, reducing the amount of data that need be transmitted from the target base station 5-2 to the UE 3.

Alternatively, rather than the source base station 5-1 transmitting, in step S1708, an indication of a remaining portion of the AI/ML model to be transmitted to the UE 3 by the target base station 5-2, the source base station 5-1 may transmit an indication to the target base station 5-2 that the target base station is to transmit the full AI/ML model to the UE 3 (or the target base station 5-1 may be configured to transmit the full AI/ML model to the UE 3 irrespective of receiving or not receiving an indication from the source base station 5-1). Whilst this may result in some duplication of the data for the AI/ML model received at the UE 3, the AI/ML model can be more reliably transmitted to the UE 3. The source base station 5-1 may include the AI/ML model ID or version number in the transmission of step S1708. If the target base station 5-2 transmits the full AI/ML model rather than transmitting only the remaining portion of the model, then the UE 3 deletes (e.g. no longer stores, or allows to be overwritten), the portion of the AI/ML model received from the source base station 5-1. The UE 3 may delete the portion of the AI/ML model received from the source base station 5-1 in response to receiving an indication that the portion of the AI/ML model is to be deleted from the source base station 5-1 (e.g. in step S1707) or the target base station 5-2 (e.g. in step S1711).

Transmission of the AI/ML model to the UE 3 may be via RRC transmissions or user plane (UP) transmissions. In a case where the AI/ML model is transmitted to the UE 3 using one or more RRC messages (e.g. when the message of Step 1707 is an RRC reconfiguration message), the segments may be RRC segments, each having an associated RRC segment number. The RRC segment number of the last segment received by the UE 3 may be stored by the UE 3. The RRC segment number of the last segment transmitted to the UE 3 may be stored at the source base station 5-1. In a case where the UE 3 is receiving the AI/ML model from the source base station 5-1 via a user plane transmission, the UE 3 may receive the AI/ML model via a DRB established between the source base station 5-1 and the UE 3. In this case, the segments may be PDCP segments having a corresponding PDCP sequence number (SN), or may be generated using a dedicated protocol layer (e.g. the AI/ML protocol layer described above).

In step S1710 the UE 3 transmits an indication to the target base station 5-2 that configuration of the UE 3 for the handover to the target base station 5-2 is complete. The handover configuration complete message may be an RRC Reconfiguration Complete message.

Whilst in the example of FIG. 17 the target base station 5-2 may transmit the AI/ML model, for use by the UE 3 after the handover, to the source base station 5-1, this need not necessarily be the case. Alternatively, the target base station 5-2 may transmit the AI/ML model to the UE 3 in step S1711, after the handover to the target base station 5-2 is complete. Advantageously, whilst this may result in a delay before the UE 3 can begin to use the AI/ML model (due to the time taken to transmit the AI/ML model to the UE 3 by the target base station 5-2), interruption of the transmission of the AI/ML model by the handover procedure is beneficially avoided.

It will be appreciated that handover of the UE 3 may occur: from a source base station 5-1 that does not support use of AI/ML models by the UE 3 to a target base station 5-2 that supports use of AI/ML models by the UE 3; from a source base station 5-1 that supports use of AI/ML models by the UE 3 to a target base station 5-2 that does not support use of AI/ML models by the UE 3; or from a source base station 5-1 that supports use of AI/ML models by the UE 3 to a target base station 5-2 that also supports use of AI/ML models by the UE 3 (although not necessarily the same models, as described with reference to FIG. 17).

An AI/ML model stored at the UE 3 may be part of a UE context. The UE 3 may have an AI/ML model stored in the memory of the UE 3 when the UE 3 is connected to the source base station 5-1, and the UE 3 may be configured to maintain a model in the memory of the UE 3 even if the AI/ML model is not supported for use at the target base station 5-2. This is beneficial, for example, if a further handover to another base station (or back to the source base station 5-1) that supports the AI/ML model occurs, since it avoids the need for the UE 3 to re-obtain the model. The UE 3 may determine whether to maintain an AI/ML model that is not supported at the target base station 5-2 in a memory (e.g. one or more buffers) of the UE 3 based on the available memory of the UE 3. For example, if the memory of the UE 3 has sufficient space available for storing the AI/ML model that is not supported at the target base station 5-2, then the UE 3 may determine to maintain the model in the memory of the UE 3.

If the UE 3 is to use, following the handover, an AI/ML model that is supported for use at the target base station 5-2, but the AI/ML model is not available (e.g. stored) at the target base station 5-2, then the UE 3 may transmit the AI/ML model to the target base station 5-2 following, or as part of, the handover procedure (in any suitable transmission from the UE 3 to the target base station 5-2). This scenario may occur, for example, if the target base station 5-2 includes, in step S1704, an indication of an AI/ML model that is supported for use at the target base station 5-2 but is not currently stored at the target base station 5-2. Alternatively, the source base station 5-1 may transmit the AI/ML model to the target base station (or may transmit information for obtaining the AI/ML model to the target base station, e.g. a network address for use by the target base station 5-2 to obtain the model). For example, if the AI/ML information of step S1704 indicates that the target base station 5-2 supports an AI/ML model, but the model is not available at the target base station 5-2, then the source base station may determine to transmit the model to the target base station 5-2 (in which case, rather than the source base station 5-1 receiving a model from the target base station 5-2 in step S1705, the source base station 5-2 instead transmits the model to the target base station 5-2).

Even when the same AI/ML model is supported by both the source base station 5-1 and the target base station 5-2 for a particular use case or function, the target base station 5-2 may support a different version of the model, or may support use of the model using a different set of parameters than the source base station 5-1. In a case where the target base station 5-2 supports a different version of the model, an indication of the supported version of the model (e.g. version number) can be transmitted from the target base station 5-2 to the source base station in step S1704 or S1705. Similarly, an indication of AI/ML model parameters supported by the target base station 5-2 may be provided in the transmission of step S1704 or S1705. If the handover request of step S1703 includes parameters used at the source base station 5-1 for a particular model, then the target base station 5-2 may provide an indication of subset of the parameters that are to be changed, for use of the AI/ML model by the UE 3 following the handover.

After receiving the AI/ML model version or AI/ML model parameters from the target base station 5-2, the source base station 5-2 can then transmit an indication of a model version of AI/ML model parameters to use, after the handover, for a particular model to the UE 3 (e.g. in step S1706, or in an RRC reconfiguration message in S1707). The UE 3 can then configure the AI/ML model appropriately in step S1709 based on the AI/ML version for use, or based on the AI/ML model parameters. It will be appreciated that if the AI/ML model for use by the UE 3 following the handover is already stored at the UE 3 before the handover occurs, and only AI/ML model parameters for use with the AI/ML model are to be changed/updated, then the UE 3 need not necessarily receive the model from the source base station 5-1 or the target base station 5-2 in steps S1706, S1707 or S1711, since the model is already stored at the UE 3 and need only be reconfigured.

Whilst in the example of FIG. 17 information indicating the AI/ML models supported by the source base station 5-1 is transmitted in the Handover Request step S1703, and information indicating the AI/ML models supported by the target base station 5-2 is transmitted in the Handover Request Acknowledgement message of step S1704, the information indicating the supported AI/ML models need not necessarily be transmitted as part of the handover procedure. Alternatively, for example, the information indicating the supported models could be exchanged in an Xn Setup procedure (e.g. for initializing the Xn connection between the two base stations 5) or Xn Update procedure. The Xn setup procedure or Xn update procedure could be performed before the handover procedure of FIG. 17, in which case the AI/ML information and the AI/ML information response need not necessarily be transmitted in steps S1703 and S1704 (although the information could still be included, as this may enable more up-to-date AI/ML information to be exchanged if the supported AI/ML models have changed following the Xn setup/update procedure).

A dedicated information element could be provided in an Xn Setup Request message, an Xn Setup Response message, or an Xn Update message, transmitted from the source base station 5-1 to the target base station 5-2, or from the target base station 5-2 to the source base station 5-1, for indicating one or more AI/ML models supported by the base station 5 that transmits the message (e.g. per use case or function, or for a particular UE 3 or type/class of UE 3). The dedicated information element may comprise one or more bits for indicating whether a particular AI/ML function or capability is supported. The dedicated information element may comprise one or more bits for indicating whether AI/ML models are supported for a particular use case (e.g. encoding/decoding of CSI feedback, beam management, or UE positioning accuracy methods). The dedicated information element may comprise one or more bits for indicating a model ID or version number for one or more supported AI/ML models. The dedicated information element may comprise one or more bits for indicating that a cell of the base station is part of a particular AI/ML model function area. The dedicated information element may comprise one or more bits for indicating a model transfer method that is supported by the base station (e.g. model transfer architecture, such as CP-based AI/ML model transmission or UP-based AI/ML model transmission).

When information for obtaining an AI/ML model transmitted in step S1705 or S1706 comprises information for obtaining the model from another node in the network (e.g. the AI/ML server), the transmission of the AI/ML model from the AI/ML server 151 to the UE 3 may be performed as described above with reference to FIG. 13, where the base station 5 of FIG. 13 may be either the source base station 5-1 or the target base station 5-2 of FIG. 17. The transmission of the AI/ML model from the AI/ML server 151 to the UE 3 may be an UP-based transmission. When the transmission is an UP-based transmission, as shown in FIG. 13 there may be communication between the base station 5 and the AI/ML server 151 (e.g. the request for the AI/ML model transmitted from the base station to the AI/ML server 151), and there may be direct communication between the UE 3 and the AI/ML server 151 (for example, the UE 3 may transmit a request for the AI/ML model directly to the AI/ML server 151).

After the target base station 5-2 receives the handover request in step S1703 of FIG. 17, the target base station 5-2 may transmit, to the AI/ML server 151, an indication of whether transmission of an AI/ML model to the UE 3 (or transmission of a new version of the model, or updated parameters for use with the AI/ML model) is required. The AI/ML server 15 may then transmit the AI/ML model to the UE 3 via the source cell or the target cell (e.g. as described with reference to steps S1403c and S1404 of FIG. 13, where the base station 5 is the source base station 5-1 if the model is transmitted via the source cell, and the base station 5 is the target base station 5-2 if the model is transmitted via the target cell). Alternatively, for example, the AI/ML model could be transmitted from the AI/ML server 151 to the UE 3 via another entity in the network, such as via the AMF 10-1 using corresponding NAS signaling as described above.

### (User Equipment)

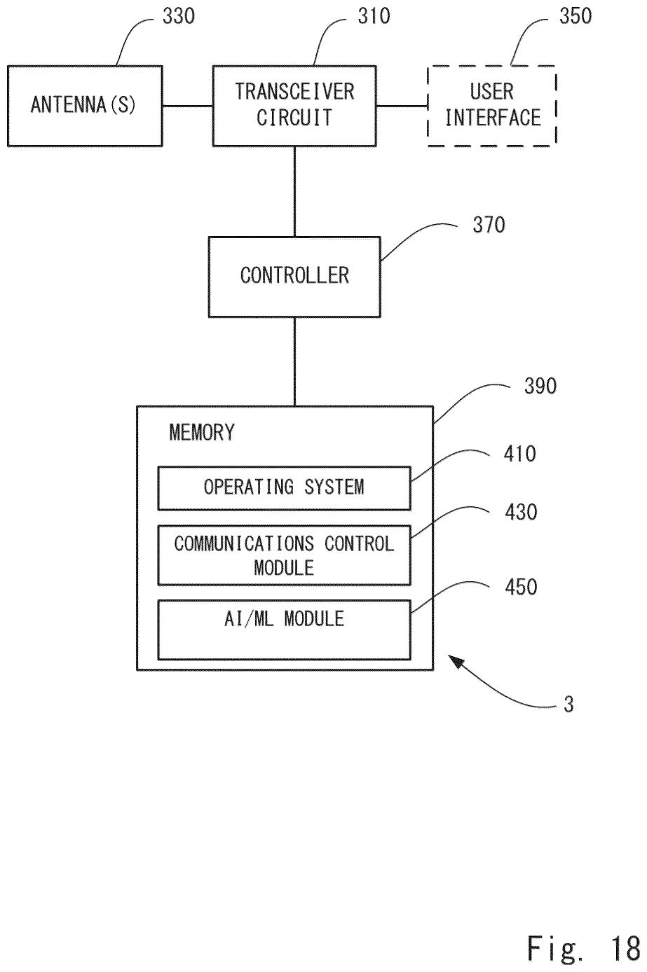

FIG. 18 is a schematic block diagram illustrating the main components of a UE 3 as shown in FIG. 1.

As shown, the UE 3 has a transceiver circuit 310 that is operable to transmit signals to and to receive signals from a base station 5 via one or more antennas 330 (e.g., comprising one or more antenna elements). The UE 3 has a controller 370 to control the operation of the UE 3. The controller 370 is associated with a memory 390 and is coupled to the transceiver circuit 310. Although not necessarily required for its operation, the UE 3 might, of course, have all the usual functionality of a conventional UE 3 (e.g. a user interface 350, such as a touch screen/keypad/microphone/speaker and/or the like for, allowing direct control by and interaction with a user) and this may be provided by any one or any combination of hardware, software, and firmware, as appropriate. Software may be pre-installed in the memory 390 and/or may be downloaded via the communication network or from a removable data storage device (RMD), for example.

The controller 370 is configured to control overall operation of the UE 3 by, in this example, program instructions or software instructions stored within the memory 390. As shown, these software instructions include, among other things, an operating system 410, a communications control module 430, and an AI/ML module 450.

The communications control module 430 is operable to control the communication between the UE 3 and its one or more serving base stations 5 (and other communication devices connected to the base station 5, such as further UEs and/or core network nodes). The communications control module 430 is configured for the overall handling uplink communications via associated uplink channels (e.g. via a physical uplink control channel (PUCCH), random access channel (RACH), and/or a physical uplink shared channel (PUSCH)) including both dynamic and semi-static signaling (e.g., SRS). The communications control module 430 is also configured for the overall handling of receipt of downlink communications via associated downlink channels (e.g. via a physical downlink control channel (PDCCH) and/or a physical downlink shared channel (PDSCH)) including both dynamic and semi-static signaling (e.g., CSI-RS). The communications control module 430 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like. The communications control module 430 may be configured to control communications in accordance with any of the methods described above (for example, to transmit a measurement report according to any of the methods described above).

The AI/ML module 450 is operable to control the use of an AI/ML model at the UE 3 (e.g. to generate one or more inferences using the model). The AI/ML module 450 may be configured to perform any of the AI/ML related functions of the UE 3 of any of the methods described above.

### (Base Station)

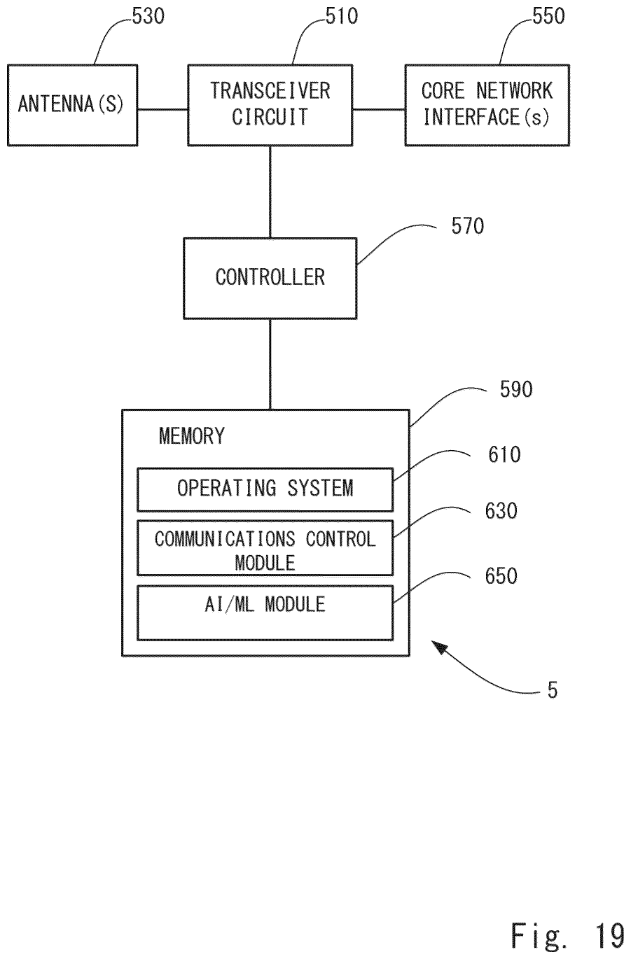

FIG. 19 is a schematic block diagram illustrating the main components of the base station 5 for the communication system 1 shown in FIG. 1. As shown, the base station 5 has a transceiver circuit 510 for transmitting signals to and for receiving signals from the communication devices (such as UEs 3) via one or more antennas 530 (e.g. a single or multi-panel antenna array/massive antenna), and a core network interface 550 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 570 to control the operation of the base station 5. The controller 570 is associated with a memory 590. Software may be pre-installed in the memory 590 and/or may be downloaded via the communication system 1 or from a removable data storage device (RMD), for example. The controller 570 is configured to control the overall operation of the base station 5 by, in this example, program instructions or software instructions stored within the memory 590.

As shown, these software instructions include, among other things, an operating system 610, a communications control module 630, and an AI/ML module 650.

The communications control module 630 is operable to control the communication between the base station 5 and UEs 3 and other network entities that are connected to the base station 5. The communications control module 630 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signaling (e.g., SRS). The communications control module 630 is also configured for the overall handling the transmission of downlink communications via associated downlink channels (e.g. via a physical downlink control channel (PDCCH) and/or a physical downlink shared channel (PDSCH)) including both dynamic and semi-static signaling (e.g., CSI-RS).

The communications control module 630 is responsible for managing full duplex (e.g., SBFD) communication including, where appropriate, the segregation of UL and DL communication via different physical antenna elements. The communications control module 630 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for providing related configuration signaling to the UE 3; and the like. The communications control module 630 may be configured to control communications in accordance with any of the methods described above (for example, to receive or transmit UE 3 mobility information, or a handover request).

The AI/ML module 650 may be configured to perform any of the AI/ML related functions of the UE 3 of any of the methods described above. The base station 5 may be configured to train or re-train the AI/ML model as described above (for example, in response to UE mobility information that is fed back to the base station 5 from another node in the network, such as another base station 5).

### (Core Network Node/Function)

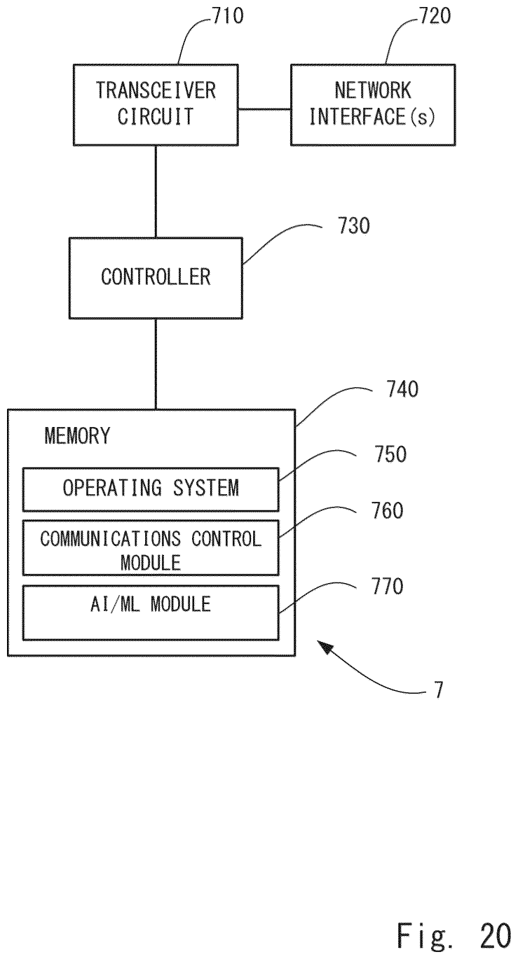

FIG. 20 is a block diagram illustrating the main components of a core network node or function, such as the AMF, CPF, the UPF, the SMF or OAM. As shown, the core network function includes a transceiver circuit 710 which is operable to transmit signals to and to receive signals from other nodes (including the UE 3, the base station 5, and other core network nodes) via a network interface 720. A controller 730 controls the operation of the core network function in accordance with software stored in a memory 740. The software may be pre-installed in the memory 740 and/or may be downloaded via the communication system 1 or from a removable data storage device (RMD), for example. The software includes, among other things, an operating system 750, and a communications control module 760.

The communications control module 760 is responsible for handling (generating/sending/receiving) signaling between the core network function and other nodes, such as the UE 3, the base station 5, and other core network nodes. The signaling may include for example a UE context/UE capability indication of a UE 3 related to energy saving.

As shown in FIG. 20 the core network node/function may also include an AI/ML module 770. If present, the AI/ML module 770 is operable to perform any of the AI/ML related functions of the core network node/function according to any of the methods described above. The core network node/function may be configured for training or re-training the AI/ML model as described above (for example, in response to UE mobility information that is fed back to the core network node/function from another node in the network, such as the base station 5).

### Modifications and Alternatives

As those skilled in the art will appreciate, a number of modifications and alternatives can be made to the above example embodiments whilst still benefiting from the disclosure embodied therein.

Whilst the above examples have been described with reference to an AI/ML model, it will be appreciated that the above described methods are advantageous even when the model is not an AI/ML model. Any other suitable type of model or function may be used to generate inferences (e.g. determinations or predictions).

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The memories shown above may be formed by a volatile memory or a nonvolatile memory, however, the memories may be formed by a combination of a volatile memory and a nonvolatile memory.

In the above example embodiments, a number of software modules were described. As those skilled in the art will appreciate, the software modules may be provided in compiled or un-compiled form and may be supplied as a signal over a computer network, or on a recording medium. Further, the functionality performed by part or all of this software may be performed using one or more dedicated hardware circuits. However, the use of software modules is preferred as it facilitates updating of functionalities.

A software to configure the software modules can be stored using various types of non-transitory computer readable media or tangible storage media to be supplied to a computer. By way of example, and not limitation, non-transitory computer readable media or tangible storage media can include a random-access memory (RAM), a read-only memory (ROM), a flash memory, a solid-state drive (SSD) or other memory technologies, compact disk-read only memory (CD-ROM,) compact disk-read/write (CD-R/W), digital versatile disk (DVD), Blu-ray disc ((R): Registered trademark) or other optical disk storage, magnetic cassettes, magnetic tape, magnetic disk storage or other magnetic storage devices. The program may be transmitted on a transitory computer readable medium or a communication medium. By way of example, and not limitation, transitory computer readable media or communication media can include electrical, optical, acoustical, or other form of propagated signals.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine;

a dryer; an electronic fan or related appliance; a cleaner etc.). A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in a memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

TABLE 2

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

Part of or all the foregoing aspects can be described as in the following appendixes, but the present disclosure is not limited thereto. Some or all of elements specified in any of Supplementary Notes may be applied to various types of hardware, software, and recording means for recording software, systems, and methods.

### Supplementary Note 1

A method performed by a user equipment, UE, the method comprising:
running an artificial intelligence or machine learning, AI/ML, model, in a cell of a first access network node;
receiving, from the first access network node, information for a handover from the first access network node to a second access network node, wherein the information for the handover includes information related to continuity of the running the AI/ML model; and
initiating a process based on the information related to the continuity of the running the AI/ML model.

### Supplementary Note 2

The method according to Supplementary Note 1, wherein
the information related to the continuity of the running the AI/ML indicates whether the second access network node supports the AI/ML model, or not.

### Supplementary Note 3

The method according to Supplementary Note 1 or 2, wherein
the running the AI/ML model is performed for a particular use case or feature, and
the information related to the continuity of the running the AI/ML indicates whether the second access network node supports the particular use case or feature on the AI/ML model, or not.

### Supplementary Note 4

The method according to any one of Supplementary Notes 1 to 3, wherein
the information related to the continuity of the running the AI/ML indicates that the AI/ML model or at least one parameter used for the AI/ML model is needed to update for the continuity.

### Supplementary Note 5

The method according to any one of Supplementary Notes 1 to 4, wherein
the information related to the continuity of the running the AI/ML includes at least one of:
information indicating at least one AI/ML model which the second access network node supports,
information indicating at least one AI/ML model which the second access network node suggests using, or
information indicating a respective status of at least one AI/ML model which the second access network node supports.

### Supplementary Note 6

The method according to Supplementary Note 2, wherein
in a case where the information related to the continuity of the running the AI/ML indicates that the second access network node does not support the AI/ML model, initiating a procedure for using another AI/ML model than the AI/ML model.

### Supplementary Note 7

The method according to Supplementary Note 6, wherein
the procedure includes at least one of:
receiving, from the first access network node, the another AI/ML model, or
switching to the another AI/ML model stored in the UE, for the continuity of the running the AI/ML model.

### Supplementary Note 8

The method according to Supplementary Note 6 or 7, wherein
in a case where the information related to the continuity of the running the AI/ML indicates that the second access network node does not support the AI/ML model, the AI/ML model is not deleted from the UE.

### Supplementary Note 9

The method according to any one of Supplementary Notes 6 to 8, wherein
the initiating the procedure for the using the another AI/ML model is performed before the handover.

### Supplementary Note 10

The method according to any one of Supplementary Notes 1 to 9, further comprising:
transmitting, to the second access network node, preference information for at least one AI/ML model to use for the continuity of the running the AI/ML model.

### Supplementary Note 11

The method according to Supplementary Note 10, wherein
in a case where the second access network node does not have the at least one AI/ML model indicated by the preference information, the at least one AI/ML model is transmitted from the first access network node or the UE.

### Supplementary Note 12

The method according to Supplementary Note 10, further comprising:
in a case where the second access network node does not have the at least one AI/ML model indicated by the preference information, transmitting to the second access network node, an indication for causing the second access network node to receive the at least one AI/ML model from a server or a core network node which the at least one AI/ML model has.

### Supplementary Note 13

The method according to any one of Supplementary Notes 1 to 12, further comprising:
receiving, from the first access network node, at least one AI/ML model which is transmitted by the second access network node, during the handover.

### Supplementary Note 14

The method according to Supplementary Note 13, wherein the receiving the at least one AI/ML model is performed via at least one of:
a Radio Resource Control, RRC, message, or
a user plane data.

### Supplementary Note 15

The method according to Supplementary Note 13 or 14, further comprising:
in a case where the receiving the at least one AI/ML model is not completed by the completion of the handover, discarding a part of the at least one AI/ML model which the UE has received.

### Supplementary Note 16

The method according to Supplementary Note 13 or 14, further comprising:
in a case where the receiving the at least one AI/ML model is not completed by the completion of the handover, receiving, from the second access network node, a part of the at least one AI/ML model which the UE has not received.

### Supplementary Note 17

The method according to Supplementary Note 16, further comprising:
transmitting, to the second access network node, status information indicating a part of the at least one AI/ML model which the UE has received, and
wherein the receiving the part of the at least one AI/ML model which the UE has not received is performed based on the status information.

### Supplementary Note 18

The method according to Supplementary Note 16, wherein status information indicating a part of the at least one AI/ML model which the first access network node has transmitted to the UE is transmitted from the first access network node to the second access network node, and
wherein the receiving the part of the at least one AI/ML model which the UE has not received is performed based on the status information.

### Supplementary Note 19

The method according to any one of Supplementary Notes 1 to 18, wherein
the information related to continuity of the running the AI/ML model is transmitted from the second access network node to the first access network node.

### Supplementary Note 20

The method according to Supplementary Note 19, wherein
the information related to continuity of the running the AI/ML model is transmitted from the second access network node to the first access network node, in at least one of:
a handover request acknowledge message,
an inter-base station interface setup response message, or
an access network node configuration update acknowledge message.

### Supplementary Note 21

The method according to Supplementary Note 19 or 20, wherein the information related to continuity of the running the AI/ML model is transmitted upon transmission of model information related to the AI/ML model which the UE is running, from the first access network node to the second access network node.

### Supplementary Note 22

The method according to Supplementary Note 21, wherein
the model information includes at least one of:
an identity of the AI/ML model,
information indicating a version of the AI/ML model,
information indicating an area corresponding to the AI/ML model, or information indicating a respective AI/ML model which the UE selected for each use case or feature.

### Supplementary Note 23

The method according to Supplementary Note 21 or 22, wherein the model information is included in at least one of:
a handover request message,
an inter-base station interface setup request message, or
an access network node configuration update message.

### Supplementary Note 24

The method according to Supplementary Note 23, wherein
the model information is included in the handover request message,
the handover request message causes the second access network node to indicate to a core network node or a server whether update of the AI/ML model is necessary or not, and
in a case where the core network node or the server requests to update the AI/ML model, an updated AI/ML model is transmitted from the core network node or the server to the UE.

### Supplementary Note 25

The method according to Supplementary Note 21 or 22, wherein
the model information is included in the inter-base station interface setup request message, or the access network node configuration update message, and
the model information includes at least one of:
capability information indicating support of the AI/ML model per use case or feature, or
information indicating a supported transmission method for transmission of the AI/ML model.

### Supplementary Note 26

The method according to any one of Supplementary Notes 1 to 25, wherein
the information related to continuity of the running the AI/ML model includes at least one of:
an identity of the AI/ML model,
information indicating a version of the AI/ML model,
information indicating an area corresponding to the AI/ML model, or
information indicating a respective AI/ML model which the UE selected for each use case or feature.

### Supplementary Note 27

A method performed by a first access network node, the method comprising:

transmitting, to a user equipment, UE which is running an artificial intelligence or machine learning, AI/ML, model, in a cell of the first access network node, information for a handover from the first access network node to a second access network node, wherein the information for the handover includes information related to continuity of the running the AI/ML model, and
wherein the information related to the continuity of the running the AI/ML model causes the UE to initiate a process for the continuity of the running the AI/ML model.

### Supplementary Note 28

The method according to Supplementary Note 27, wherein
the information related to the continuity of the running the AI/ML indicates whether the second access network node supports the AI/ML model, or not.

### Supplementary Note 29

The method according to Supplementary Note 27 or 28, wherein
the running the AI/ML model is performed for a particular use case or feature, and
the information related to the continuity of the running the AI/ML indicates whether the second access network node supports the particular use case or feature on the AI/ML model, or not.

### Supplementary Note 30

The method according to any one of Supplementary Notes 27 to 29, wherein
the information related to the continuity of the running the AI/ML indicates that the AI/ML model or at least one parameter used for the AI/ML model is needed to update for the continuity.

### Supplementary Note 31

The method according to any one of Supplementary Notes 27 to 30, wherein
the information related to the continuity of the running the AI/ML includes at least one of:

information indicating at least one AI/ML model which the second access network node supports,
information indicating at least one AI/ML model which the second access network node suggests using, or
information indicating a respective status of at least one AI/ML model which the second access network node supports.

### Supplementary Note 32

The method according to Supplementary Note 28, wherein
in a case where the information related to the continuity of the running the AI/ML indicates that the second access network node does not support the AI/ML model, initiating a procedure for using another AI/ML model than the AI/ML model.

### Supplementary Note 33

The method according to Supplementary Note 32, wherein the procedure includes at least one of:
transmitting, to the user equipment, the another AI/ML model, or causing the UE to switch to the another AI/ML model stored in the UE, for the continuity of the running the AI/ML model.

### Supplementary Note 34

The method according to Supplementary Note 32 or 33, wherein in a case where the information related to the continuity of the running the AI/ML indicates that the second access network node does not support the AI/ML model, the AI/ML model is not deleted from the UE.

### Supplementary Note 35

The method according to any one of Supplementary Notes 32 to 34, wherein
the initiating the procedure for the using the another AI/ML model is performed before the handover.

### Supplementary Note 36

The method according to any one of Supplementary Notes 27 to 35, further comprising:
in a case where the second access network node does not have at least one AI/ML model to use for the continuity of the running the AI/ML model, indicated by the UE, transmitting the at least one AI/ML model to the second access network node.

### Supplementary Note 37

The method according to any one of Supplementary Notes 27 to 35, further comprising:
in a case where the second access network node does not have at least one AI/ML model to use for the continuity of the running the AI/ML model, indicated by the UE, transmitting to the second access network node, an indication for causing the second access network node to receive the at least one AI/ML model from a server or a core network node which the at least one AI/ML model has.

### Supplementary Note 38

The method according to any one of Supplementary Notes 27 to 37, further comprising:
transmitting, to the UE, at least one AI/ML model which is transmitted by the second access network node, during the handover.

### Supplementary Note 39

The method according to Supplementary Note 38, wherein the transmitting the at least one AI/ML model is performed via at least one of:
a Radio Resource Control, RRC, message, or a user plane data.

### Supplementary Note 40

The method according to Supplementary Note 38 or 39, further comprising:
in a case where the transmitting the at least one AI/ML model is not completed by the completion of the handover, transmitting, to the second access network node, information indicating that the transmitting the at least one AI/ML model is not completed by the completion of the handover.

### Supplementary Note 41

The method according to Supplementary Note 40, wherein information indicating the transmitting the at least one AI/ML model is not completed by the completion of the handover includes information indicating:
a part of the at least one AI/ML model which the UE has received, or
a part of the at least one AI/ML model which the UE has not received.

### Supplementary Note 42

The method according to any one of Supplementary Notes 27 to 41, further comprising:
receiving, from the second access network node, the information related to continuity of the running the AI/ML model.

### Supplementary Note 43

The method according to Supplementary Note 42, wherein
the information related to continuity of the running the AI/ML model is included in at least one of:

a handover request acknowledge message,
an inter-base station interface setup response message, or
an access network node configuration update acknowledge message.

### Supplementary Note 44

The method according to Supplementary Note 42 or 43, further comprising:

transmitting, to the second access network node, model information related to the AI/ML model which the UE is running, and
wherein the receiving the information related to the continuity of the running the AI/ML model is performed based on the transmitting the model information.

### Supplementary Note 45

The method according to Supplementary Note 44, wherein the model information includes at least one of:
an identity of the AI/ML model,
information indicating a version of the AI/ML model,
information indicating an area corresponding to the AI/ML model, or
information indicating a respective AI/ML model which the UE selected for each use case or feature.

### Supplementary Note 46

The method according to Supplementary Note 44 or 45, wherein the model information is included in at least one of:

a handover request message,
an inter-base station interface setup request message, or an access network node configuration update message.

### Supplementary Note 47

The method according to Supplementary Note 46, wherein
the model information is included in the handover request message,
the handover request message causes the second access network node to indicate to a core network node or a server whether update of the AI/ML model is necessary or not, and
in a case where the core network node or the server requests to update the AI/ML model, an updated AI/ML model is transmitted from the core network node or the server to the UE.

### Supplementary Note 48

The method according to Supplementary Note 44 or 45, wherein
the model information is included in the inter-base station interface setup request message, or the access network node configuration update message, and
the model information includes at least one of:
capability information indicating support of the AI/ML model per use case or feature, or
information indicating a supported transmission method for transmission of the AI/ML model.

### Supplementary Note 49

The method according to any one of Supplementary Notes 27 to 48, wherein
the information related to continuity of the running the AI/ML model includes at least one of:
an identity of the AI/ML model,
information indicating a version of the AI/ML model,
information indicating an area corresponding to the AI/ML model, or information indicating a respective AI/ML model which the UE selected for each use case or feature.

### Supplementary Note 50

A method performed by a second access network node, the method comprising:

transmitting, to a first access network node, information for a handover from the first access network node to the second access network node, wherein the information for the handover includes information related to continuity of running, by a user equipment, UE, an artificial intelligence or machine learning, AI/ML, model, in a cell of the first access network node, and
wherein the information related to the continuity of the running the AI/ML model is transmitted to the UE to cause the UE to initiate a process for the continuity of the running the AI/ML model.

### Supplementary Note 51

The method according to Supplementary Note 50, wherein
the information related to the continuity of the running the AI/ML indicates whether the second access network node supports the AI/ML model, or not.

### Supplementary Note 52

The method according to Supplementary Note 50 or 51, wherein
the running the AI/ML model is performed for a particular use case or feature, and
the information related to the continuity of the running the AI/ML indicates whether the second access network node supports the particular use case or feature on the AI/ML model, or not.

### Supplementary Note 53

The method according to any one of Supplementary Notes 50 to 52, wherein
the information related to the continuity of the running the AI/ML indicates that the AI/ML model or at least one parameter used for the AI/ML model is needed to update for the continuity.

### Supplementary Note 54

The method according to any one of Supplementary Notes 50 to 53, wherein
the information related to the continuity of the running the AI/ML includes at least one of:
information indicating at least one AI/ML model which the second access network node supports,
information indicating at least one AI/ML model which the second access network node suggests using, or
information indicating a respective status of at least one AI/ML model which the second access network node supports.

### Supplementary Note 55

The method according to Supplementary Note 51, wherein
in a case where the information related to the continuity of the running the AI/ML indicates that the second access network node does not support the AI/ML model, the information related to the continuity of the running the AI/ML causes the UE to initiate a procedure for using another AI/ML model than the AI/ML model.

### Supplementary Note 56

The method according to Supplementary Note 55, wherein the procedure includes at least one of:
transmitting, from the first access network node to the UE, the another AI/ML model, or
switching, by the UE, to the another AI/ML model stored in the UE, for the continuity of the running the AI/ML model.

### Supplementary Note 57

The method according to Supplementary Note 55 or 56, wherein
in a case where the information related to the continuity of the running the AI/ML indicates that the second access network node does not support the AI/ML model, the AI/ML model is not deleted from the UE.

### Supplementary Note 58

The method according to any one of Supplementary Notes 55 to 57, wherein
the initiating the procedure for the using the another AI/ML model is performed before the handover.

### Supplementary Note 59

The method according to any one of Supplementary Notes 50 to 58, further comprising:
receiving, from the UE, preference information for at least one AI/ML model to use for the continuity of the running the AI/ML model.

### Supplementary Note 60

The method according to Supplementary Note 59, further comprising:
in a case where the second access network node does not have the at least one AI/ML model indicated by the preference information,
requesting the first access network node or the UE to transmit, to the second access network node, the at least one AI/ML model.

### Supplementary Note 61

The method according to Supplementary Note 59, further comprising:
in a case where the second access network node does not have the at least one AI/ML model indicated by the preference information:
receiving, from the UE, an indication; and
receiving, from a server or a core network node which the at least one AI/ML model has, the at least one AI/ML model, based on the indication.

### Supplementary Note 62

The method according to any one of Supplementary Notes 50 to 61, further comprising:
transmitting, the UE via the first access network node, at least one AI/ML model, during the handover.

### Supplementary Note 63

The method according to Supplementary Note 62, wherein
the transmitting the at least one AI/ML model is performed via at least one of:
a Radio Resource Control, RRC, message, or
a user plane data.

### Supplementary Note 64

The method according to Supplementary Note 62 or 63, further comprising:
in a case where the transmitting the at least one AI/ML model is not completed by the completion of the handover, transmitting, to the UE directly:
a whole part of the at least one AI/ML model, or
a part of the at least one AI/ML model which the UE has not received.

### Supplementary Note 65

The method according to Supplementary Note 64, further comprising:
receiving, from the UE, status information indicating a part of the at least one AI/ML model which the UE has received, and
wherein the transmitting the part of the at least one AI/ML model which the UE has not received is performed based on the status information.

### Supplementary Note 66

The method according to Supplementary Note 64, further comprising:
receiving status information indicating a part of the at least one AI/ML model which the first access network node has transmitted to the UE, and
wherein the transmitting the part of the at least one AI/ML model which the UE has not received is performed based on the status information.

### Supplementary Note 67

The method according to any one of Supplementary Notes 50 to 66, wherein
the information related to continuity of the running the AI/ML model is included in at least one of:
a handover request acknowledge message,
an inter-base station interface setup response message, or
an access network node configuration update acknowledge message.

### Supplementary Note 68

The method according to any one of Supplementary Notes 50 to 67, further comprising:
receiving, from the first access network node, model information related to the AI/ML model which the UE is running, and
wherein the transmitting the information related to continuity of the running the AI/ML model is performed based on the model information.

### Supplementary Note 69

The method according to Supplementary Note 68, wherein
the model information includes at least one of:
an identity of the AI/ML model,
information indicating a version of the AI/ML model,
information indicating an area corresponding to the AI/ML model, or
information indicating a respective AI/ML model which the UE selected for each use case or feature.

### Supplementary Note 70

The method according to Supplementary Note 68 or 69, wherein
the model information is included in at least one of:
a handover request message,
an inter-base station interface setup request message, or
an access network node configuration update message.

### Supplementary Note 71

The method according to Supplementary Note 70, wherein
the model information is included in the handover request message, and the method comprises:
indicating, to a core network node or a server, whether update of the AI/ML model is necessary or not; and
in a case where the core network node or the server requests to update the AI/ML model:
receiving, from the core network node or the server, an updated AI/ML model; and
transmitting the updated AI/ML model to the UE.

### Supplementary Note 72

The method according to Supplementary Note 68 or 69, wherein
the model information is included in the inter-base station interface setup request message, or the access network node configuration update message, and
the model information includes at least one of:
capability information indicating support of the AI/ML model per use case or feature, or
information indicating a supported transmission method for transmission of the AI/ML model.

### Supplementary Note 73

The method according to any one of Supplementary Notes 50 to 72, wherein
the information related to continuity of the running the AI/ML model includes at least one of:
an identity of the AI/ML model,
information indicating a version of the AI/ML model,
information indicating an area corresponding to the AI/ML model, or
information indicating a respective AI/ML model which the UE selected for each use case or feature.

### Supplementary Note 74

A user equipment, UE, comprising:
means for running an artificial intelligence or machine learning, AI/ML, model, in a cell of a first access network node;
means for receiving, from the first access network node, information for a handover from the first access network node to a second access network node, wherein the information for the handover includes information related to continuity of the running the AI/ML model; and
means for initiating a process based on the information related to the continuity of the running the AI/ML model.

### Supplementary Note 75

A first access network node comprising:
means for transmitting, to a user equipment, UE which is running an artificial intelligence or machine learning, AI/ML, model, in a cell of the first access network node, information for a handover from the first access network node to a second access network node, wherein the information for the handover includes information related to continuity of the running the AI/ML model, and
wherein the information related to the continuity of the running the AI/ML model causes the UE to initiate a process for the continuity of the running the AI/ML model.

### Supplementary Note 76

A second access network node comprising:
means for transmitting, to a first access network node, information for a handover from the first access network node to the second access network node, wherein the information for the handover includes information related to continuity of running, by a user equipment, UE, an artificial intelligence or machine learning, AI/ML, model, in a cell of the first access network node, and
wherein the information related to the continuity of the running the AI/ML model is transmitted to the UE to cause the UE to initiate a process for the continuity of the running the AI/ML model.

This application is based upon and claims the benefit of priority from United Kingdom Patent Application No. 2302758.4, filed on Feb. 24, 2023, the disclosure of which is incorporated herein in its entirety by reference.

### REFERENCE SIGNS LIST

1 . . . COMMUNICATION SYSTEM
3 . . . USER EQUIPMENT
5, 5-1, 5-2 . . . RAN NODE (BASE STATION, RAN EQUIPMENT)
7 . . . CORE NETWORK
9 . . . CELL
10 . . . CONTROL PLANE FUNCTION
11 . . . USER PLANE FUNCTION
20 . . . EXTERNAL DATA NETWORK
41 . . . DATA COLLECTION FUNCTION
43 . . . MODEL TRAINING FUNCTION
45 . . . MODEL INFERENCE FUNCTION
47 . . . ACTOR
50 . . . DISTRIBUTED UNIT
60 . . . CENTRAL UNIT
151 . . . AI/ML SERVER
180 . . . FIRST CELL
181 . . . SECOND CELL
182 . . . THIRD CELL
310 . . . TRANSCEIVER CIRCUIT
330 . . . ANTENNA
350 . . . USER INTERFACE
370 . . . CONTROLLER
390 . . . MEMORY
410 . . . OPERATING SYSTEM
430 . . . COMMUNICATIONS CONTROL MODULE
450 . . . AI/ML MODULE
451 . . . TRANSCEIVER CIRCUIT
453 . . . RU INTERFACE
454 . . . CU INTERFACE
457 . . . CONTROLLER
459 . . . MEMORY
461 . . . OPERATING SYSTEM
463 . . . COMMUNICATIONS CONTROL MODULE
465 . . . F1 MODULE
468 . . . DU-RU MODULE
472 . . . DU MANAGEMENT MODULE
473 . . . UE PROFILE MANAGEMENT MODULE
475 . . . MOBILITY MODULE
510 . . . TRANSCEIVER CIRCUIT
530 . . . ANTENNA
550 . . . CORE NETWORK INTERFACE
551 . . . TRANSCEIVER CIRCUIT
554 . . . DU INTERFACE
555 . . . CU INTERFACE
557 . . . CONTROLLER
559 . . . MEMORY
561 . . . OPERATING SYSTEM
563 . . . COMMUNICATIONS CONTROL MODULE
565 . . . F1 MODULE
566 . . . E1 MODULE
568 . . . N2 MODULE
569 . . . N3 MODULE
570 . . . CONTROLLER
571 . . . CU-UP MANAGEMENT MODULE
572 . . . CU-CP MANAGEMENT MODULE
573 . . . UE PROFILE MANAGEMENT MODULE
575 . . . MOBILITY MODULE
590 . . . MEMORY
610 . . . OPERATING SYSTEM
630 . . . COMMUNICATIONS CONTROL MODULE
650 . . . AI/ML MODULE
710 . . . TRANSCEIVER CIRCUIT
720 . . . NETWORK INTERFACE
730 . . . CONTROLLER
740 . . . MEMORY
750 . . . OPERATING SYSTEM
760 . . . COMMUNICATIONS CONTROL MODULE
770 . . . AI/ML MODULE

What is claimed is:

1.-76. (canceled)

77. A method performed by a mobile device, the method comprising:
running an artificial intelligence/machine learning (AI/ML) model, in a cell of a first access network node;
receiving, from the first access network node, information for a handover from the first access network node to a second access network node, wherein the information for the handover includes information related to continuity of the running the AI/ML model; and
initiating a process based on the information related to the continuity of the running the AI/ML model, and wherein
at least one AI/ML model is received from the second access network node during or after the handover.

78. The method according to claim 77, wherein
the at least one AI/ML model is received from the second access network node via the first access network node during the handover.

79. The method according to claim 78, wherein
the receiving the at least one AI/ML model is performed via at least one of:
a Radio Resource Control (RRC) message, or
a user plane data.

80. The method according to claim 78, further comprising:
in a case where the receiving the at least one AI/ML model is not completed by the completion of the handover, discarding a part of the at least one AI/ML model which the mobile device has received.

81. The method according to claim 78, further comprising:
in a case where the receiving the at least one AI/ML model is not completed by the completion of the handover, receiving, from the second access network node, a part of the at least one AI/ML model which the mobile device has not received.

82. The method according to claim 81, further comprising:
transmitting, to the second access network node, status information indicating a part of the at least one AI/ML model which the mobile device has received, and
wherein the receiving the part of the at least one AI/ML model which the mobile device has not received is performed based on the status information.

83. The method according to claim 81, wherein
status information indicating a part of the at least one AI/ML model which the first access network node has transmitted to the mobile device is transmitted from the first access network node to the second access network node, and
wherein the receiving the part of the at least one AI/ML model which the mobile device has not received is performed based on the status information.

84. The method according to claim 77, wherein
the information related to continuity of the running the AI/ML model is transmitted from the second access network node to the first access network node.

85. The method according to claim 84, wherein
the information related to continuity of the running the AI/ML model is transmitted from the second access network node to the first access network node, in at least one of:
a handover request acknowledge message,
an inter-base station interface setup response message, or
an access network node configuration update acknowledge message.

86. The method according to claim 84, wherein
the information related to continuity of the running the AI/ML model is transmitted upon transmission of model information related to the AI/ML model which the mobile device is running, from the first access network node to the second access network node.

87. The method according to claim 86, wherein
the model information includes at least one of:
an identity of the AI/ML model,
information indicating a version of the AI/ML model,
information indicating an area corresponding to the AI/ML model, or
information indicating a respective AI/ML model which the mobile device selected for each use case or feature.

88. The method according to claim 86, wherein
the model information is included in at least one of:
a handover request message,
an inter-base station interface setup request message, or
an access network node configuration update message.

89. The method according to claim 88, wherein
the model information is included in the handover request message,
the handover request message causes the second access network node to indicate to a core network node or a server whether update of the AI/ML model is necessary or not, and
in a case where the core network node or the server requests to update the AI/ML model, an updated AI/ML model is transmitted from the core network node or the server to the UE.

90. The method according to claim 86, wherein
the model information is included in the inter-base station interface setup request message, or the access network node configuration update message, and
the model information includes at least one of:
capability information indicating support of the AI/ML model per use case or feature, or
information indicating a supported transmission method for transmission of the AI/ML model.

91. The method according to claim 77, wherein
the information related to continuity of the running the AI/ML model includes at least one of:
an identity of the AI/ML model,
information indicating a version of the AI/ML model,
information indicating an area corresponding to the AI/ML model, or
information indicating a respective AI/ML model which the mobile device selected for each use case or feature.

92. A method performed by a first access network node, the method comprising:
transmitting, to a mobile device which is running an artificial intelligence/machine learning (AI/ML) model, in a cell of the first access network node, information for a handover from the first access network node to a second access network node, wherein the information for the handover includes information related to continuity of the running the AI/ML model, and
wherein the information related to the continuity of the running the AI/ML model causes the mobile device to initiate a process for the continuity of the running the AI/ML model, and wherein
at least one AI/ML model is transmitted from the second access network node to the mobile device during or after the handover.

93. A method performed by a second access network node, the method comprising:
transmitting, to a first access network node, information for a handover from the first access network node to the second access network node, wherein the information for the handover includes information related to continuity of running, by a mobile device, an artificial intelligence/machine learning (AI/ML) model, in a cell of the first access network node, and
wherein the information related to the continuity of the running the AI/ML model is transmitted to the mobile device to cause the mobile device to initiate a process for the continuity of the running the AI/ML model, and wherein
at least one AI/ML model is transmitted to the mobile device during or after the handover.

94. A mobile device comprising:
at least one memory configured to store instructions; and
at least one processor configured to execute the instructions to:
run an artificial intelligence/machine learning (AI/ML) model, in a cell of a first access network node;
receive, from the first access network node, information for a handover from the first access network node to a second access network node, wherein the information for the handover includes information related to continuity of the running the AI/ML model; and
initiate a process based on the information related to the continuity of the running the AI/ML model, and wherein
at least one AI/ML model is received from the second access network node during or after the handover.

95. A first access network node comprising:
at least one memory configured to store instructions; and
at least one processor configured to execute the instructions to:
transmit, to a mobile device which is running an artificial intelligence/machine learning (AI/ML) model, in a cell of the first access network node, information for a handover from the first access network node to a second access network node, wherein the information for the handover includes information related to continuity of the running the AI/ML model, and
wherein the information related to the continuity of the running the AI/ML model causes the mobile device to initiate a process for the continuity of the running the AI/ML model, and wherein
at least one AI/ML model is transmitted from the second access network node to the mobile device during or after the handover.

96. A second access network node comprising:
at least one memory configured to store instructions; and
at least one processor configured to execute the instructions to:
transmit, to a first access network node, information for a handover from the first access network node to the second access network node, wherein the information for the handover includes information related to continuity of running, by a mobile device, an artificial intelligence/machine learning (AI/ML) model, in a cell of the first access network node, and
wherein the information related to the continuity of the running the AI/ML model is transmitted to the mobile device to cause the mobile device to initiate a process for the continuity of the running the AI/ML model, and wherein
at least one AI/ML model is transmitted to the mobile device during or after the handover.
